(19) United States
(12) Patent Application Publication
(10) Pub. No.: US 2002/0028075 A1
(43) Pub. Date: Mar. 7, 2002

(54) Film image signal generation apparatus

(75) Inventors: Kazuyuki Kazami, Tokyo (JP); Norikazu Yokonuma, Yokohama (JP); Hideo Hibino, Kawasaki (JP); Hisashi Okutsu, Yokohama (JP)

Correspondence Address: OLIFF & BERRIDGE, PLC, P.O. BOX 19928, ALEXANDRIA, VA, 22320, US

(73) Assignee: Nikon Corporation, Tokyo (JP)

(21) Appl. No.: 09/986,383

(22) Filed: Nov. 8, 2001

Related U.S. Application Data
(63) Continuation of application No. 09/506,359, filed on Feb. 17, 2000.
Application No. 09/506,359 is a division of application No. 08/658,245, filed on Jun. 4, 1996, now abandoned.

(30) Foreign Application Priority Data
Jun. 5, 1995 (JP) 7-137717
Jun. 5, 1995 (JP) 7-137718
Jun. 5, 1995 (JP) 7-137719
Jun. 16, 1995 (JP) 7-150398
Jul. 25, 1995 (JP) 7-189112
Jul. 25, 1995 (JP) 7-189113
Jul. 26, 1995 (JP) 7-190662
Jul. 26, 1995 (JP) 7-190663
Jul. 26, 1995 (JP) 7-190664
Jul. 26, 1995 (JP) 7-190665

(51) Int. Cl. G03B 1/00

(52) U.S. Cl. 396/387

(57) ABSTRACT

If the final film frame is set to the image formation position, the winding on of the film from the cartridge is prohibited; and, if an operation member is operated to designate the winding on of the film from the cartridge, either by one film frame or by fast forwarding, a warning is emitted. Further, if the first film frame is set to the image formation position, the winding backward of the film into the cartridge is prohibited; and, if an operation member is operated to designate the winding backward of the film into the cartridge, either by one film frame or by fast rewinding, a warning is emitted. Further, when the first film frame on the film is set to the image formation position and a forwarding mode is set for outputting image signals while winding forward the film from the cartridge one film frame at a time, an image signal of the first film frame is outputted; while when the first film frame on the film is not set to the image formation position and this forwarding mode is set, the film is wound out of the cartridge by one film frame.

### BACKGROUND OF THE INVENTION

1. Field of the Invention

The present invention relates to a film image signal generation apparatus which generates a signal corresponding to an image which has been photographed onto a photographic film.

2. Related Background Art

A film image display apparatus which displays upon a video monitor an image on a film stored in a film cartridge, after development of the film, is per se known—for example, refer to Japanese Laying Open Patent Application No. 5-75922.

There are various types of film forwarding mode in which this type of apparatus can be operated in order to forward the photographic frame to the image formation position so as to display the required image, such as a film protruding mode for protruding the film out from the film cartridge, a fast forwarding mode, a rewinding mode, a single frame forwarding mode, a scan forwarding mode, etc.

Further, typically a magnetic recording portion is formed upon a film which is to be used with this apparatus, in order to record various items of information upon the film magnetically; and then it is possible to record various items of photographic information for each photographic frame in this way. With the above described apparatus, the information which is magnetically recorded is replayed when forwarding the film, as a magnetic head for playback contacts the film.

Yet further, a camera is per se known which records information other than images, which is related to the contents of the film or photographing, upon the leader portion of the film or in each film frame magnetically or optically.

### SUMMARY OF THE INVENTION

The objective of the present invention is to improve the operability of a film image signal generation apparatus when the film is being forwarded.

In order to attain this objective, with the present invention, if the final film frame is set to the image formation position, the winding on of the film from the cartridge is prohibited; and, if an operation member is operated to designate the winding on of the film from the cartridge, either by one film frame or by fast forwarding, a warning is emitted. Further, if the first film frame is set to the image formation position, the winding backward of the film into the cartridge is prohibited; and, if an operation member is operated to designate the winding backward of the film into the cartridge, either by one film frame or by fast rewinding, a warning is emitted. By doing this, the film can never be forwarded as far as a portion thereof in which no exposed film frame exists, and the operability when forwarding the film is enhanced.

Further, with the present invention, when the first film frame on the film is set to the image formation position and a forwarding mode is set for outputting image signals while winding forward the film from the cartridge one film frame at a time, an image signal of the first film frame is outputted; while when the first film frame on the film is not set to the image formation position and this forwarding mode is set, the film is wound out of the cartridge by one film frame. By doing this, it is possible to output the signals of images upon the film in order from the first film frame.

Moreover, with the present invention, when the final film frame on the film is set to the image formation position and a forwarding mode is set for outputting image signals while winding the film backward into the cartridge one film frame at a time, an image signal of the final film frame is outputted; while when the final film frame on the film is not set to the image formation position and this forwarding mode is set, the film is wound backward into the cartridge by one film frame. By doing this, it is possible to output the signals of images upon the film in order from the final film frame.

Further, with the present invention, information for each film frame is replayed while the film is being forwarded to its final film frame, and a signal corresponding to this information for each film frame is outputted. If this signal is utilized to display the information on a monitor, for example, it is possible for the operator, before displaying the images upon the film, to be apprised of what type of images have been photographed upon each of the film frames of the current film, and it is possible for him directly to forward the film frame which he wishes to display to the image formation position and to display it, and the like, which improves the operability of the apparatus when forwarding the film.

Further, with the present invention, any film frame which is designated by an operation member can be forwarded to the image formation position of an image taking up device, so that an image signal thereof can be outputted. By doing this, for a film on which the contents of the images for each frame are known, a signal of the image of any film frame which the operator desires to get can immediately be obtained.

Further, with the present invention, in a process of initial forwarding of the film by projecting the film out from the cartridge, forwarding is controlled so as to bring the first film frame of the film to the image formation position of the image taking up device, and in response to this operation information which is magnetically or optically recorded on a recording area of the first film frame of the film or in a leader portion thereof is replayed, and a signal corresponding to the information for the first film frame or the film leader portion which has been replayed is outputted without outputting an image signal of the first film frame which has been positioned by the initial forwarding process. By doing this, it is possible to output a signal corresponding to the film information in advance, before selecting a forwarding mode for the film cartridge which is loaded.

Further, with the present invention, along with projecting the film from the cartridge and moving the film so as to bring a portion thereof one frame towards the leader portion thereof from its first film frame to the image formation position, information other than images which is magnetically or optically recorded upon the leader portion of the film is replayed and a signal corresponding to the information is outputted. When no such information other than images is recorded upon the leader portion of the film, along with moving the film so as to bring the first film frame thereof to the image formation position, information other than images which is magnetically or optically recorded in the first film frame of the film is replayed and a signal corresponding to the information is outputted. By doing this, by outputting the signal corresponding to the information related to the film in advance before selecting a film forwarding mode for the film cartridge which is loaded, it is possible to select the most suitable forwarding mode corresponding to this film cartridge.

Further, with the present invention, magnetically recorded information of each film frame is replayed while moving the film, and the highest numbered film frame for which magnetically recorded information has been replayed is set as the final film frame of the film. By doing this, useless operation for forwarding non exposed portions of the film to the image formation position is avoided.

A further objective of the present invention is to minimize wear and tear upon the film, and also to abate abrasion of the magnetic head.

In order to achieve this objective, with the present invention, during information replay operation, the magnetic head is contacted to the film only for film frames for which information is not already stored in an information storage circuit. By doing this, wear and tear upon the film is minimized, and also abrasion of the magnetic head is abated.

A further objective of the present invention is to make it possible to deal with both a film upon which no such information other than images is recorded and a film upon which such information other than images is recorded.

In order to achieve this objective, with the present invention, while projecting the film out from the cartridge and replaying information other than images recorded in the leader portion of the film and in the first film frame thereof, if no such information other than images is recorded in the leader portion of the film or in the first film frame thereof, the first film frame is moved to the image formation position and a signal corresponding to an image of the first film frame is outputted. Further, if information other than images is magnetically or optically recorded in the leader portion of the film, the film is moved so as to bring a portion thereof one frame towards the leader portion thereof from the first film frame thereof to the image formation position, and a signal corresponding to the information other than images which is recorded upon the leader portion of the film is outputted; and, if no such information other than images is recorded in the leader portion of the film but such information other than images is recorded in the first film frame of the film, the film is forwarded so as to bring the first film frame thereof to the image formation position, and a signal corresponding to the information other than images which is recorded upon the first film frame of the film is outputted. By doing this, it is possible to deal both with a film upon which such information other than images is recorded and with a film upon which no such information is recorded, and with a film of the former type the information relating to the contents of the film can be obtained before selecting a forwarding mode for the film cartridge which is loaded, and the most suitable film forwarding mode can be selected for the actual contents of the film. On the other hand, with a film of the latter type, an image of the first frame on the film can be obtained before selecting a forwarding mode for the film cartridge which is loaded, and accordingly it is possible to check upon the contents of the film by inspecting the first film frame thereof, so that again the most suitable film forwarding mode can be selected for the actual contents of the film.

A final objective of the present invention is to prohibit the setting of the index mode for a film upon which no such information for the various film frames thereof is magnetically recorded.

In order to achieve this objective, with the present invention, the magnetically recorded information for the first film frame of the film is replayed while moving the first film frame of the film to the image formation position, and the setting of the index mode is prohibited if no such magnetically recorded information has been replayed from the first film frame. By doing this, the useless operation is avoided of forwarding in index mode as far as the final film frame thereof a film upon which no magnetic recording region is provided, or upon which no information is magnetically recorded although such a magnetic recording region is provided.

### BRIEF DESCRIPTION OF THE DRAWINGS

FIG. 1 is a schematic structural figure showing the main mechanical parts of a film image signal generation apparatus according to the preferred embodiment of the present invention;

FIG. 2 is an electrical block circuit diagram showing the main electrical parts of this film image signal generation apparatus according to the preferred embodiment of the present invention;

FIG. 3 is a perspective view of a film cartridge which is suitable for use in this film image signal generation apparatus according to the preferred embodiment of the present invention;

FIG. 4 is a view showing a portion of a film which is stored in the FIG. 3 film cartridge;

FIG. 5 is a flow chart showing a first portion of a main processing routine for a microcomputer which is incorporated in the FIG. 2 circuit;

FIG. 6 is a flow chart, continuing from FIG. 5, showing a second portion of this main processing routine for this microcomputer;

FIG. 7 is a flow chart, continuing from FIG. 6, showing a third and final portion of this main processing routine for this microcomputer;

FIG. 8 is a flow chart showing an initialization processing routine;

FIG. 9 is a flow chart showing a routine for processing optical data upon the film;

FIG. 10 is a flow chart showing a routine for processing magnetic data;

FIG. 11 is a flow chart showing a film forwarding mode determination processing routine;

FIG. 12 is a flow chart showing a variant embodiment for this film forwarding mode determination processing routine;

FIG. 13 is a flow chart showing a single frame advance mode processing routine;

FIG. 14 is a flow chart showing a single frame backup mode processing routine;

FIG. 15 is a flow chart showing an index mode processing routine;

FIG. 16 is a flow chart showing a frame designation mode processing routine;

FIG. 17 is a flow chart showing a skip mode processing routine;

FIG. 18 is a flow chart showing a film rewinding mode processing routine;

FIG. 19 is a flow chart showing a variant embodiment of the portion shown in FIG. 6 of the main processing routine for the preferred embodiment;

FIG. 20 is a flow chart showing another variant embodiment of the portion shown in FIG. 6 of the main processing routine for the preferred embodiment;

FIG. 21 is a flow chart showing a variant embodiment of the portion shown in FIG. 7 of the main processing routine for the preferred embodiment;

FIG. 22 is a flow chart showing a variant embodiment of the index mode processing routine shown in FIG. 15 for the preferred embodiment; and:

FIG. 23 is a flow chart showing another variant embodiment of the index mode processing routine shown in FIG. 15 for the preferred embodiment.

### DETAILED DESCRIPTION OF THE PREFERRED EMBODIMENT

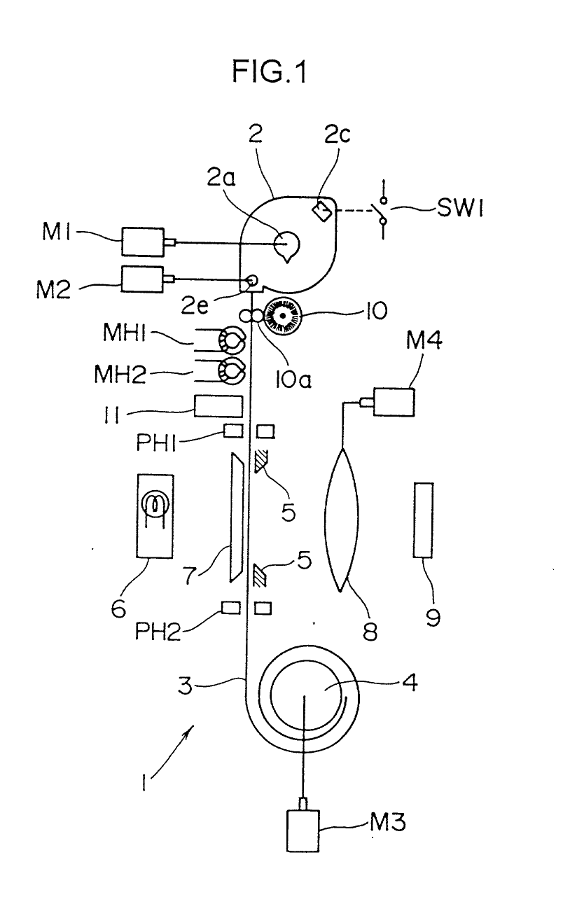

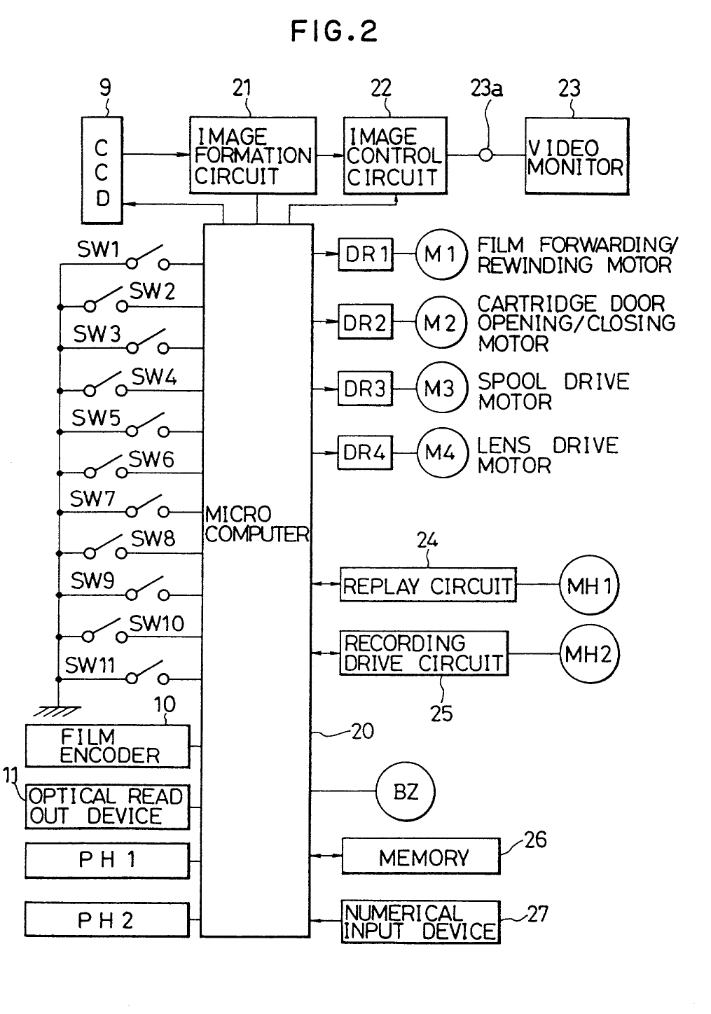

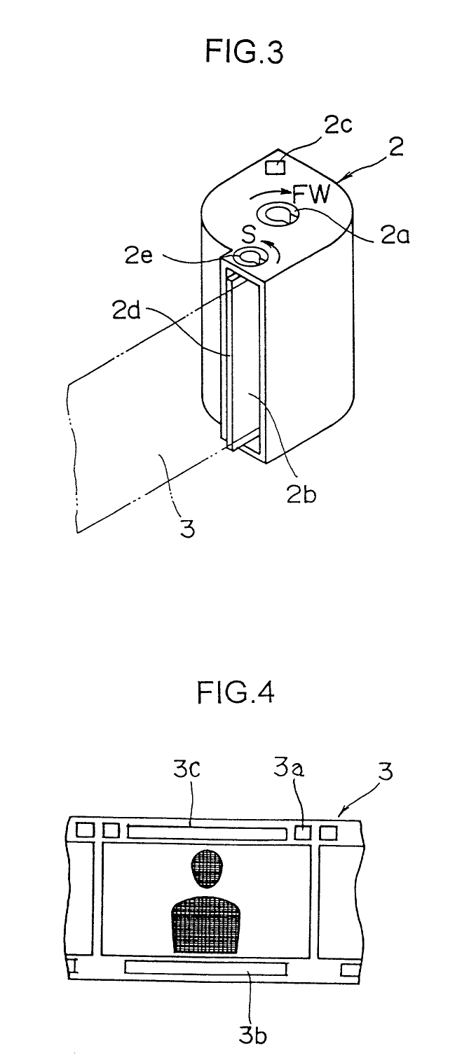

The preferred embodiment of the present invention will now be explained. FIG. 1 is a schematic structural figure showing the main mechanical parts of a film image signal generation apparatus according to the preferred embodiment, while FIG. 2 is an electrical block circuit diagram thereof. Further, FIG. 3 is a perspective view of a film cartridge which is used in this film image signal generation apparatus according to the preferred embodiment, while FIG. 4 is a view showing a portion of a film which is stored in this film cartridge.

Referring to FIG. 1, a film cartridge 2 which is to be loaded into this film image signal generation apparatus 1 comprises a spool shaft 2a, as shown in FIG. 3, which, when it is driven so as to be rotated in the rotational direction shown as FW in the figure, causes a film 3 to be forwarded out from the film cartridge 2 through a forwarding slot 2b; while, when it is driven in the opposite rotational direction, it winds the film 3 back into the film cartridge 2. As shown in FIG. 1, the spool shaft 2a is driven by a film forwarding/rewinding motor M1.

An indicator mechanism 2c is provided in the upper portion of the film cartridge 2 for showing whether or not the film 3 has been developed. On the other hand, a film developed switch SW1 is disposed in a cartridge chamber of the film image signal generation apparatus 1 which is not particularly shown in a position corresponding to the position of the indicator mechanism 2c, and, when the film cartridge 2 is loaded into this cartridge chamber of this film image signal generation apparatus 1, this film developed switch SW1 and the indicator mechanism 2c correspond to one another, and the film developed switch SW1 is opened by the indicator mechanism 2c if and only if the film has been developed, while otherwise said switch SW1 remains closed.

A cartridge door 2d is provided to the forwarding slot 2b of the film cartridge 2 for preventing light entering therethrough to be incident upon the film 3 while it is in the undeveloped state. When a drive shaft 2e of this cartridge door 2d is driven so as to be rotated in the direction shown by S in the figure then the cartridge door 2d is closed, while on the other hand when the drive shaft 2e is rotationally driven in the opposite direction then the cartridge door 2d is opened. As shown in FIG. 1, this drive shaft 2e of the cartridge door 2d is driven by a cartridge door opening/closing motor M2.

The film 3 which is stored within this film cartridge 2, as shown in FIG. 4, is formed with a series of perforations 3a which are pierced through one of its edges at certain intervals along its lengthwise direction. Further, a series of magnetic recording regions 3b are provided along the other edge of the film 3, each corresponding to one of the film frames upon it. Moreover, other magnetic recording regions 3c are provided between the perforations 3a.

Although the explanation provided herein of this preferred embodiment of the present invention is made by way of example in terms of a film which is photographed in a normal winding type camera in which the film is pulled frame by frame out from the film cartridge and is wound up onto a take up spool as photography is performed, it should be understood that the present invention is also applicable to a so called prewind type camera in which first the film is temporarily wound all the way out of the film cartridge onto a take up spool before photography is performed, and thereafter the film is rewound frame by frame into the film cartridge as photography is performed. The order from first to last of the film frames on a film which has been shot using such a prewind type camera is opposite to the order of the frames on a film which has been shot using a normal type camera.

Returning to FIG. 1, a take up spool 4 is rotationally driven by a spool drive motor M3 so as to wind up the film 3. An image taking up section that is constituted by an aperture 5, a source 6 of illumination, a light diffusion plate 7, an image formation lens 8, and a CCD is disposed between a film take up section that is constituted by the take up spool 4 and the spool drive motor M3 and a film rewinding section that is constituted by the film cartridge 2 and the film forwarding/rewinding motor M1, described above. The aperture 5 limits the scope of the light from the film 3 cast upon by the illumination source 6 and the light diffusion plate 7, and defines thereon an image frame which corresponds to one photographic frame. The light diffusion plate 7 diffuses and whitens the illuminating light from the illumination source 6, and also serves in this image taking up section as a pressure plate for pressing the film 3 against the aperture 5. The image formation lens 8 focuses an image of the photographic frame which is thus defined upon the film 3 by the aperture 5 upon a CCD 9, and this CCD 9 converts this image of the photographic frame thus focused by the image formation lens 8 into an electrical signal, which it outputs. Moreover, as required, the image formation lens 8 is driven by a lens drive motor M4 in order to perform focus adjustment and/or zooming.

Between this image taking up section and the film rewinding section there are provided a film encoder 10, a magnetic head MH1 for playback, a magnetic head MH2 for recording, and an optical read out device 11. The film encoder 10 is rotated by a guide roller 10a that is rotated by the film 3 as it is advanced, and outputs a pulse signal every time the film 3 is moved longitudinally by a certain predetermined amount. By counting the pulses of the pulse signal output by this film encoder 10 it is possible to detect the amount by which the film 3 has been forwarded and the speed by which it is forwarded, and control of the forwarding of the film 3 is performed based upon this detected forwarding amount. The magnetic head MH1 for playback is a magnetic head for replaying magnetic information which is previously recorded upon the recording regions 3b of the film 3, and is contacted against the film 3 by a mechanism not shown in the figures when replay of this magnetic data is to be commenced, while it is withdrawn from the film 3 when this magnetic data replay is to be concluded. The magnetic head MH2 for recording is a magnetic head for recording various items of information upon the recording regions 3b of the film 3, and is contacted against the film 3 by a mechanism not shown in the figures when recording of this magnetic data is to be commenced, while it is withdrawn from the film 3 when this magnetic data recording is to be concluded. Further, the optical read out device 11 reads out information which is optically recorded upon the film 3. It should be understood that, although in this preferred embodiment of the present invention it is shown by way of example that the magnetic head MH1 for playback and the magnetic head MH2 for recording are provided separately, this is not limitative of the present invention; it would alternatively be possible to provide a combined recording/playback head. Further, in the same manner, magnetic recording and playback heads are provided for the magnetic recording regions 3c between the perforations 3a.

Photointerruptors PH1 and PH2 for detecting the perforations 3a in the film 3 are provided before and after the aperture 5 in the direction of advancement of the film. Each of the frames upon the film 3 is in the same positional relationship to the perforations corresponding thereto, so that, in this preferred embodiment, with regard to the control of forwarding of the film 3 based upon the forwarding amount detected by the film encoder, control and determination of the position of each film frame in relation to the aperture 5 can be performed based upon the results of detection of the perforations performed by the photointerruptors PH1 and PH2.

Referring next to FIG. 2, a microcomputer 20 comprises a CPU and per se conventional circuitry associated therewith, and executes a control program as will be described hereinafter so as to perform film forwarding control, image formation control, image replay control, and magnetic information playback and recording control.

The above described CCD 9, an image formation circuit 21, and an image control circuit 22 are connected to the microcomputer 20. The image formation circuit 21 converts the image signal which is output by the CCD 9 into a video signal, while the image control circuit 22 processes this video signal and replays the image contained therein upon a video monitor 23 via a terminal 23a. The video monitor 23 can include a CRT monitor, an LCD, a plasma display or the like. It should be understood that usually a normal household type television receiver will be used as this video monitor 23, although it is also possible to provide a dedicated video monitor 23 as incorporated in this film image signal generation apparatus 1. Moreover, it should be also acceptable to use another monitoring device, such as a graphics printer or the like, instead of using the video monitor 23.

Further, various switches SW1 through SW11, and also the above described film encoder 10, the optical read out device 11, and the photointerruptors PH1 and PH2, are connected to the microcomputer 20. The film developed switch SW1 is a switch which, as described above, detects the exposure condition of the film 3, while the switch SW2 is a power supply main switch, the switch SW3 is a switch which detects whether or not a film cartridge 2 is loaded into the film cartridge chamber, and the switch SW4 is a switch which detects whether or not a lid, not particularly shown, of the film cartridge chamber is open. Further, the switches SW5 through SW10 are control switches for controlling the forwarding of the film: the switch SW5 is a single frame advance switch, the switch SW6 is a single frame backup switch, the switch SW7 is an index mode switch, the switch SW8 is a frame designation mode switch, the switch SW9 is a skip mode switch, and the switch SW10 is a film rewinding switch. Yet further, the switch SW11 is an eject switch for ejecting the film cartridge 2 from the cartridge chamber. It should be understood that, when in this specification the term “forwarding by one frame” or simply “frame forwarding” is used, this is intended to refer to the action of winding the film 3 out from the film cartridge 2 upon the take up spool 4 of the film image signal generation apparatus 1 by one film frame at a time.

Further to the microcomputer 20 there are connected drivers DR1 through DR4 for the respective motors M1 through M4, a replay circuit 24 for driving the magnetic head MH1 for playback, a recording drive circuit 25 for driving the magnetic head MH2 for recording, a buzzer Bz for emitting warnings, a memory 26, and a numerical input device 27 for inputting frame numbers and the like numerical values.

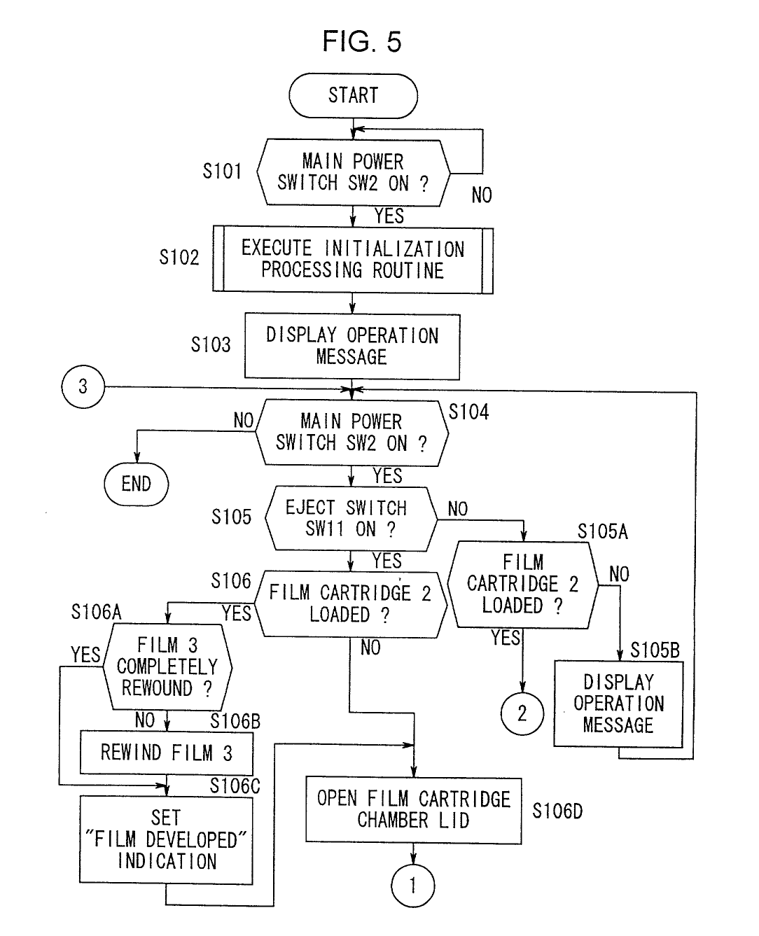

FIGS. 5 through 18 are flow charts which show various processes performed by the microcomputer 20. The operation of this preferred embodiment of the present invention will now be described with reference to these flow charts.

First the operation of a main processing routine which is executed by the microprocessor 20 will be explained, with reference to the flow charts shown in FIGS. 5 through 7.

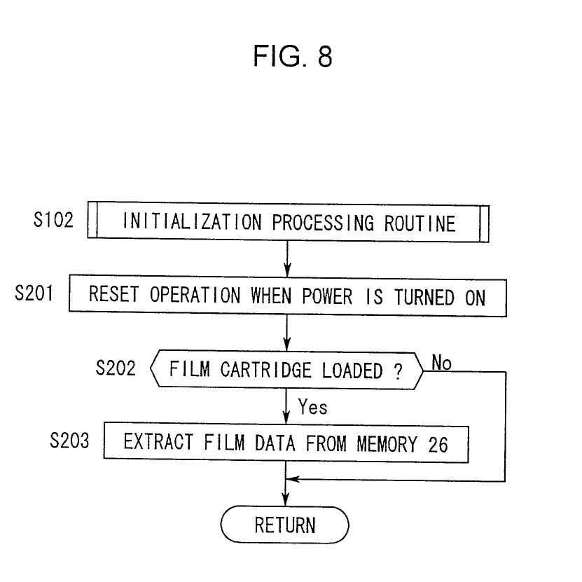

In the step S101, the system waits until the main power switch SW2 is turned on, and then starts; and in the step S102 an initialization processing routine whose flow chart is shown in FIG. 8 is executed, and the initial settings for the various parts are established.

Referring to FIG. 8, in the step S201 when the power is turned on, resetting operation is performed for the various control circuits and the various mechanisms of this apparatus. In the next step S202, a decision is made from the output of the film cartridge loaded switch SW3 as to whether or not a film cartridge 2 is currently loaded into the cartridge chamber of the film image signal generation apparatus 1, and if in fact a film cartridge 2 is loaded then the flow of control proceeds to the step S203, while if not then the flow of control skips and returns from this initialization processing routine.

After image display has been performed by this film image signal generation apparatus 1, it may happen that the power is turned off without the film cartridge 2 being removed from the apparatus 1. In this case, therefore, when the power is turned on with a film cartridge 2 already loaded, it is considered that this is a cartridge 2 of which the images have already been displayed during previous operation and from which the film information accordingly has already been replayed and stored in the memory 26, and accordingly it is considered not to be necessary again to perform the operations of replaying and storing this information. Thus, in the event that a film cartridge 2 is already loaded when the power is turned on, the information which relates to the currently loaded film cartridge 2 and which is already in the memory 26 is extracted therefrom in the step S203. This information includes information which may be recorded optically upon the surface of the film cartridge 2 including the ISO speed of the film 3 and/or the number of frames thereon, etc., and information relating to photographic conditions which may be recorded upon the leader portion of the film 3 and/or upon portions of the film which correspond to each of the film frames.

When the above described processing has been completed, the flow of control returns to the step S103 of the main control routine of FIG. 5.

After returning, in the step S103, if no film cartridge 2 is currently loaded, a message is temporarily displayed upon the video monitor 23 which invites the operator to insert a film cartridge 2, such as for example “Please insert a film cartridge”. On the other hand, if a film cartridge is currently loaded, a message is displayed upon the video monitor 23 related to the information on the cartridge which is loaded and to actions which should be performed after ingesting this information, such as for example “A film cartridge is already loaded. Information relating to this currently loaded film is as follows . . . To remove this film cartridge press the EJECT button; to continue, select an action.” Here, the information related to the cartridge which is already loaded is that information which was extracted from the memory 26 in the step S203 of the FIG. 8 subroutine as described above.

In the step S104, a decision is made as to whether or not the main power switch SW2 is still on, and if it indeed is still on then the flow of control proceeds to the step S105, while if the switch SW2 is now off then the operation of this main control processing routine terminates. In the step S105, a decision is made as to whether or not the eject switch SW11 is on, and if the eject switch SW11 is being operated then the flow of control proceeds to the step S106, while if it is not being operated then the flow of control is transferred to the step S105A.

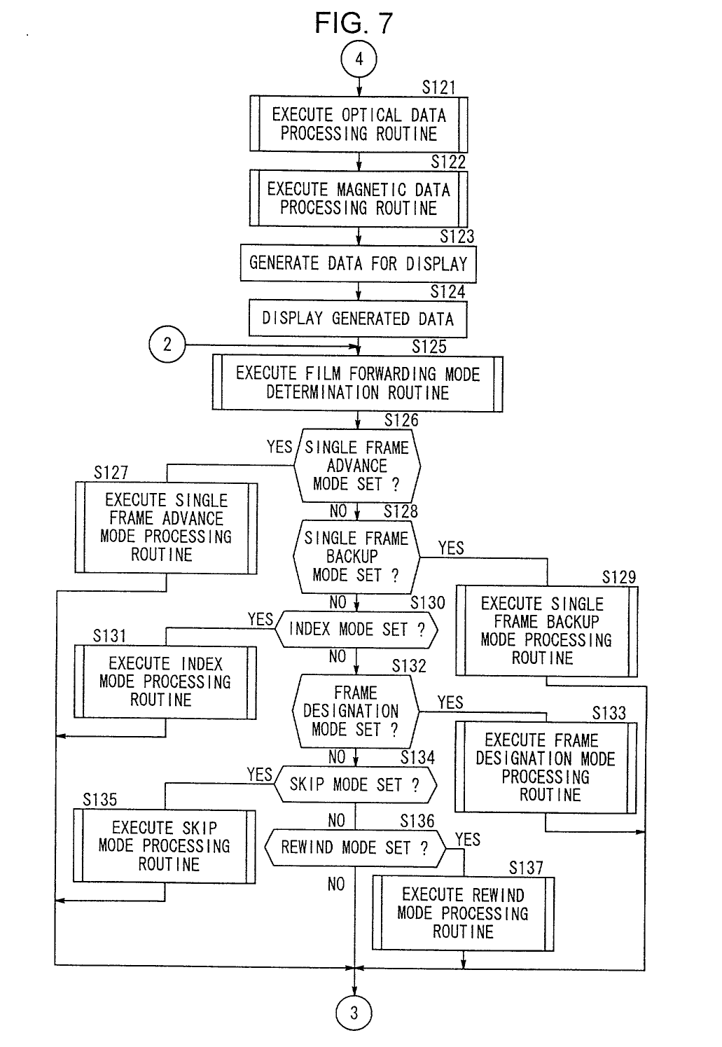

If the eject switch SW11 is not turned on, then in the step S105A a decision is made from the output of the film cartridge loaded switch SW3 as to whether or not a film cartridge 2 is currently loaded in the cartridge chamber. If a film cartridge 2 is currently loaded , then the flow of control is transferred to the step S125 shown in the FIG. 7 flow chart and the system waits for subsequent input operation, while if no film cartridge 2 is currently loaded then the flow of control proceeds to the step S105B, in which an operation message “Please load a film cartridge” is displayed upon the video monitor 23 and then the flow of control is returned to the step S104. In other words, here in the state in which the eject switch SW11 is not being operated and also no film cartridge 2 is currently loaded a message is displayed which urges the operator to insert a film cartridge, and thereafter the system waits in a continuous loop until the eject switch SW11 is operated. On the other hand, in the state in which a film cartridge 2 is currently loaded, the system waits until either the eject switch SW11 is operated or other subsequent input operation takes place.

When in the state with the main power switch SW2 on the eject switch SW11 is operated, then in the step S106 a decision is made from the output of the film cartridge loaded switch SW3 as to whether or not a film cartridge 2 is currently loaded in the cartridge chamber. If a film cartridge 2 is currently loaded , then the flow of control is transferred to the step S106A, while if not then the flow of control proceeds to the step S106D.

When the eject switch SW11 is operated when a film cartridge 2 is loaded, then in the step S106A a decision is made as to whether or not the film 3 of the film cartridge 2 which is loaded is in the completely rewound state. If the film 3 is not currently completely rewound into the film cartridge 2, then the flow of control proceeds to the step S106B in which the film 3 is rewound back into its film cartridge 2 by operation of the driver DR1 and of the film forwarding/rewinding motor M1, while if the film 3 is currently completely rewound into the film cartridge 2 then the flow of control skips this film rewinding step S106B. In either case, in the subsequent step S106C the above described indicator mechanism 2c of the film cartridge 2 is set to “film developed” by an actuator not shown in the figures. This is done in order to prevent a film cartridge 2 of which the film has already been developed from mistakenly being loaded into a camera.

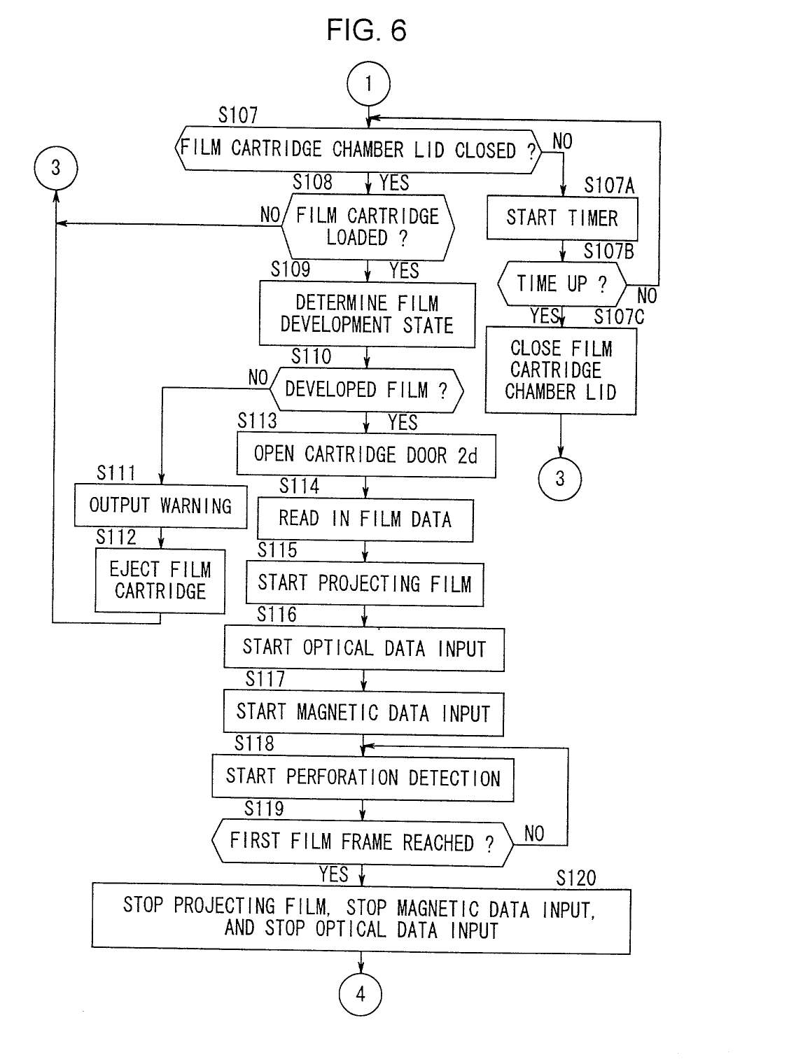

In the next step S106D, the lid of the film cartridge chamber is opened by an actuator also not shown in the figures. It would also be acceptable to provide a mechanism for not allowing this lid of the film cartridge chamber to be inadvertently opened, and this mechanism would be released when the film cartridge 2 was to be ejected. Proceeding now to the FIG. 6 flow chart, in the next step S107 a decision is made from the output of the film cartridge chamber lid open switch SW4 as to whether or not the lid of the film cartridge chamber is closed. With regard to this film cartridge chamber lid, it would also be acceptable to arrange matters so that it was automatically closed together with the operation of the eject switch SW11, or to provide a film cartridge chamber close switch so that it could be closed by manual operation. If the film cartridge chamber lid is indeed closed then the flow of control is transferred to the step S108, while if it is not closed then the flow of control proceeds to the step S107A. In the step S107A the operation of a timer is started, and in the next step S107B the system checks whether or not the period timed by the timer has exceeded a predetermined value (i.e. whether or not the timer has timed up). If the timer has not yet timed up then the flow of control returns to the previous step S107, thus to loop around until the timer times up and to continue waiting for the predetermined time period before closing the film cartridge chamber lid; while, when the timer does time up, the flow of control is transferred to the step S107C, in which the lid of the film cartridge chamber is forcibly closed by an actuator not shown in the figures. However, the film cartridge chamber lid may be opened and closed by manual operation, if it is not opened and closed by an actuator.

In the step S108, a decision is made from the output of the film cartridge loaded switch SW3 as to whether or not a film cartridge 2 is currently loaded in the cartridge chamber. If no film cartridge 2 is currently loaded , then the flow of control returns back to the step S104 of the FIG. 5 flow chart, while if indeed a film cartridge 2 is currently loaded then the flow of control proceeds to the step S109.

When a film cartridge 2 is loaded into the film cartridge chamber, then in the step S109 it is determined from the output of the film developed switch SW1 whether or not the film in the currently loaded cartridge 2 is a developed film, and in the next step S110, if the film is indeed a developed one, then the flow of control is transferred to the step S113, while if not then the flow of control proceeds to the step S111. If the film in the currently loaded cartridge 2 is an undeveloped one, then in the step S111 a warning is given by emitting an audible sound via the buzzer Bz, and in the next step S112 procedures are performed for ejecting the film cartridge 2. For example, the lid of the film cartridge chamber may be opened by the use of an actuator, so that the film cartridge 2 can be removed.

If the film in the cartridge which is currently loaded is a developed film, then in the step S113 the driver DR2 is controlled and thereby the cartridge door opening/closing motor M2 is driven, so as to open the cartridge door 2d. In the next step S114, the film data which is recorded on the surface of the film cartridge 2 such as the ISO speed and the number of film frames and the like is read in by a read in device not shown in the figures, and is stored in the memory 26.

In the next step S115 of this FIG. 6 flow chart, the driver DR1 is controlled and thereby the film forwarding/rewinding motor M1 is driven, so as to project the film 3 out from the film cartridge 2. And in the next step S116 the operation of the optical read out device 11 is started so as to start reading in the optical data recorded upon the film 3, and then in the next step S117 the magnetic head MH1 for playback is brought into contact with the film 3 and the operation of the replay circuit 24 is started so as to start replaying the magnetic data from the film 3. Normally, information relating to the direction of loading of the film cartridge in the camera during shooting thereof is recorded in an optical or magnetic format upon the leader portion of the film 3, and the reading out of this information is started at the time point when the projection of the film 3 from the film cartridge 2 is commenced. Moreover, the magnetic data recorded in the magnetic recording region 3b for the first frame on the film 3 is also read in during this projection of the film 3. Further, in the next step S118, the detection of the perforations in the edges of the film 3 by the photointerruptors PH1 and PH2 is started.

In the next step S119, a decision is made based upon the results of detection of the perforations in the film 3 by the photointerruptors PH1 and PH2 as to whether or not the first frame upon the film 3 has yet reached the image formation position, i.e. a predetermined position where it confronts the aperture 5; and if the first film frame has indeed reached the image formation position then the flow of control proceeds to the step S120, while if not then the flow of control loops back to this step S119 again. In the step S120 the driver DR1 is controlled and the film forwarding/rewinding motor M1 is driven thereby so as to stop projecting the film 3 out from the film cartridge 2, and moreover the magnetic head MH1 for playback is withdrawn from contact with the film 3 and the operation of the replay circuit 24 is terminated so as to stop replaying the magnetic data from the film 3, and further the operation of the optical read out device 11 is terminated so as to stop reading in the optical data from the film 3. When thus positioning the first film frame, it may be the case that the spool drive motor M3 is driven in correspondence with the advancing of the film 3 by the film forwarding/rewinding motor M1, in order to perform picking up and winding up action for the film 3. In this case, as well, both the motors M1 and M3 are stopped when the first frame upon the film 3 reaches the image formation position.

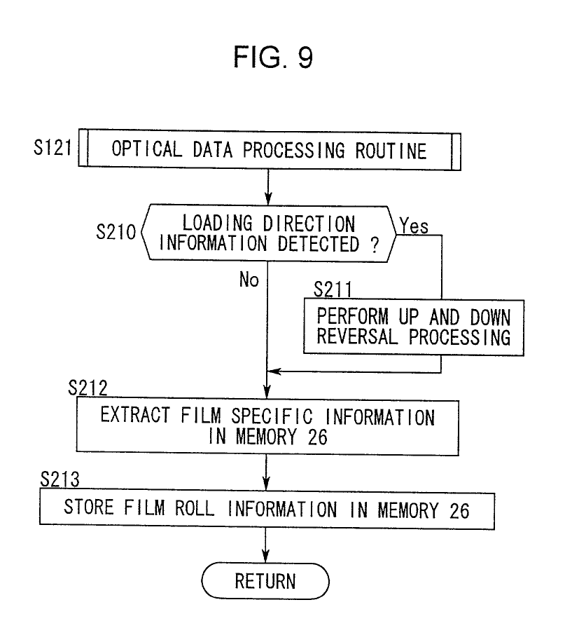

Referring now to the continuation flow chart shown in FIG. 7, in the next step S121 a routine for processing optical data whose flow chart is shown in FIG. 9 is executed. Referring to FIG. 9, in the first step S210 a decision is made as to whether or not information relating to the direction of loading of the film cartridge in the camera during shooting thereof was detected, and if such information was detected then the flow of control proceeds to the step S211, while if no such information was detected then the flow of control skips this step S211 and proceeds directly to the step S212. In this preferred embodiment of the present invention, the standard camera is taken as being one in which the film cartridge chamber is provided on the right side of the camera as seen from the rear while the film takeup spool is on its left side. It is supposed that information is optically or magnetically recorded upon the leader portion of a film which has been shot using a non standard camera in which the film cartridge chamber is provided on the left side of the camera as seen from the rear while the film takeup spool is on its right side, so as to indicate this non standard direction of shooting. If a film on which this type of loading direction information is imaged just as it is, an image on the video monitor 23 will be generated which is reversed up and down, and accordingly in this case up and down reversal processing is performed in the step S211. This up and down reversal processing, for example, may be performed mechanically by rotating the CCD 9 through 180 degrees so as to reverse the image up and down, or may be performed optically by up and down reversal of the image via the image formation lens 8. Alternatively, it would also be acceptable to reverse the image up and down electrically by processing it digitally.

Next, in the step S212, film specific information contained in the optical data which have been read out such as the ISO speed, the type of the film, the number of film frames, or the like is extracted and is stored in the memory 26. It is possible to perform color compensation for the image based upon this information. Next, in the step S213, film roll specific information recorded by the photographer and contained in the optical data such as the subject which was shot is extracted and is stored in the memory 26.

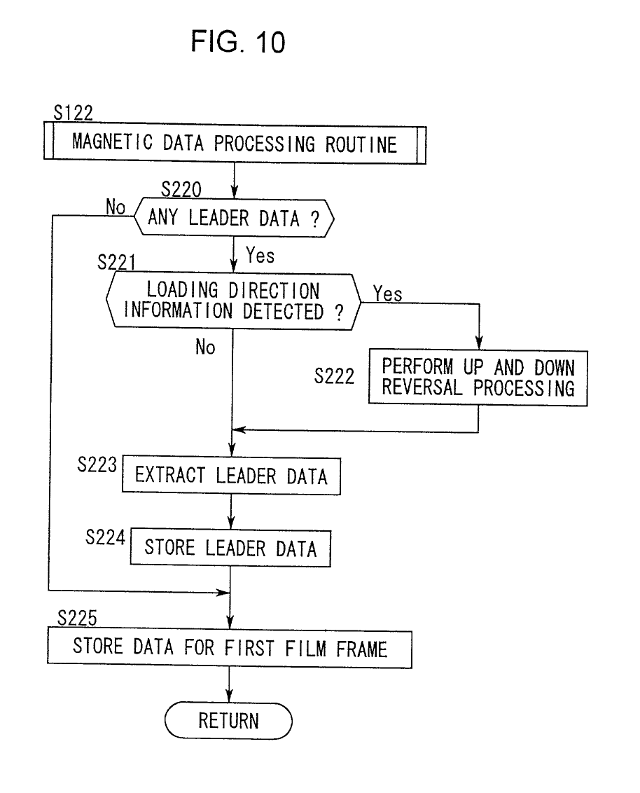

Returning to the explanation of the FIG. 7 flow chart, in the next step S122 a routine for processing magnetic data whose flow chart is shown in FIG. 10 is executed, and the magnetic data which is replayed by the replay circuit 24 and the magnetic head MH1 for playback is processed. Referring to FIG. 10, in the first step S220 a decision is made as to whether or not any magnetic data was recorded upon the leader portion of the film 3. If such magnetic data was recorded then the flow of control proceeds to the step S221, while if not then the flow of control skips to the step S225. When it is determined that magnetic data was recorded upon the leader portion of the film 3, then in the step S221 a decision is made as to whether or not any loading direction information was detected indicating that the film 3 is one which was shot in a camera of the non standard type described above. If such loading direction information was detected then the flow of control proceeds to the step S222, while if no such loading direction information was detected then the flow of control is transferred to the step S223. When such loading direction information is detected, then in the step S222 the image is reversed up and down by one of the above described methods.

In either case, in the next step S223 the magnetic information which is recorded upon the leader portion of the film 3 is extracted, and then in the next step S224 this magnetic data extracted from the leader portion of the film 3 is stored in the memory 26. And in the last step S225 of this routine the magnetic data for the first film frame, read out when the film was projected out, is stored in the memory 26.

Referring again to FIG. 7, after the processing of the optical data and of the magnetic data has been completed, the flow of control proceeds to the step S123, in which data which is to be displayed is generated based upon the data which was read out when the film 3 was projected from the film cartridge 2. And in the next step S124 this generated data for display is displayed upon the video monitor 23.

Since as described above it is so arranged that: in the process of initial forwarding of the film 3 by projecting it out from the film cartridge 2, (1) the forwarding of the film is controlled so as to bring the first film frame to the image formation position; (2) the information which was magnetically or optically recorded upon the first film frame and/or upon the leader portion of the film 3 is replayed during this operation; and (3) the information for the first film frame and/or the leader portion of the film 3 which was replayed is then displayed without displaying an image of the first film frame which is thus positioned by this initial advancement, therefore it is possible to display the information upon the film 3 in advance, before the selection of the forwarding mode for this particular film cartridge 2 which is loaded.

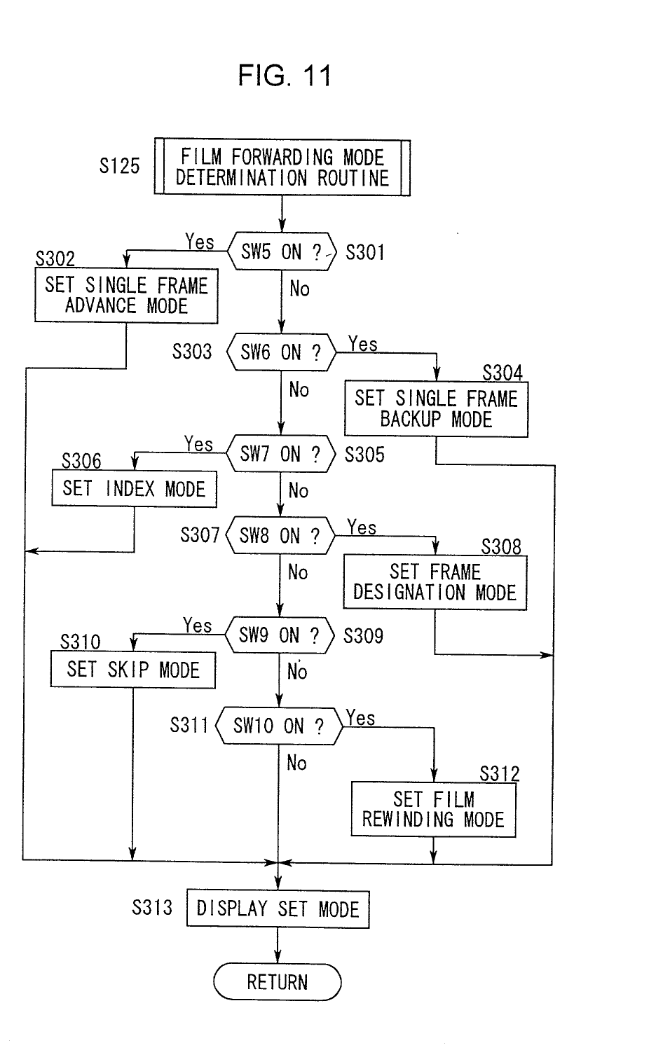

In the next step S125 of the FIG. 7 program, a routine for determination of the film forwarding mode whose flow chart is shown in FIG. 11 is executed, and it is determined which forwarding mode has been set by the operator by the use of the switches SW5 through SW10. Referring to FIG. 11, in the first step S301 a decision is made as to whether or not the single frame advance switch SW5 is being operated, and when the single frame advance switch SW5 is indeed being operated then the flow of control proceeds to the step S302, in which the single frame advance mode is set. On the other hand, if in the step S301 it is decided that the single frame advance switch SW5 is not being operated, then the flow of control is transferred to the step S303, in which a decision is made as to whether or not the single frame backup switch SW6 is being operated, and when the single frame backup switch SW6 is indeed being operated then the flow of control proceeds to the step S304, in which the single frame backup mode is set. On the other hand, if in the step S303 it is decided that the single frame backup switch SW6 is not being operated, then the flow of control is transferred to the step S305, in which a decision is made as to whether or not the index mode switch SW7 is being operated, and when the index mode switch SW7 is indeed being operated then the flow of control proceeds to the step S306, in which the index mode is set. By the index mode is meant a mode in which first the information for all of the film frames is read out and is displayed. On the other hand, if in the step S305 it is decided that the index mode switch SW7 is not being operated, then the flow of control is transferred to the step S307, in which a decision is made as to whether or not the frame designation mode switch SW8 is being operated, and when the frame designation mode switch SW8 is indeed being operated then the flow of control proceeds to the step S308, in which the frame designation mode is set. By the frame designation mode is meant a mode in which an image of any frame which is designated by the operator is displayed. On the other hand, if in the step S307 it is decided that the frame designation mode switch SW8 is not being operated, then the flow of control is transferred to the step S309, in which a decision is made as to whether or not the skip mode switch SW9 is being operated, and when the skip mode switch SW9 is indeed being operated then the flow of control proceeds to the step S310, in which the skip mode is set. By the skip mode is meant a mode in which the film frames are displayed one at a time in sequence, each for a predetermined interval. On the other hand, if in the step S309 it is decided that the skip mode switch SW9 is not being operated, then the flow of control is transferred to the step S311, in which a decision is made as to whether or not the film rewinding switch SW10 is being operated, and when the film rewinding switch SW10 is indeed being operated then the flow of control proceeds to the step S312, in which the film rewinding mode is set. On the other hand, if in the step S311 it is decided that the film rewinding switch SW10 is not being operated, then the flow of control is transferred to the step S313, to which control is transferred after all the above mentioned steps S302, S304, S306, S308, S310, and S312 as well. In this final step S313, the mode which has been set is displayed upon the video monitor 23, and then the flow of control returns to the step S126 of the FIG. 7 flow chart.

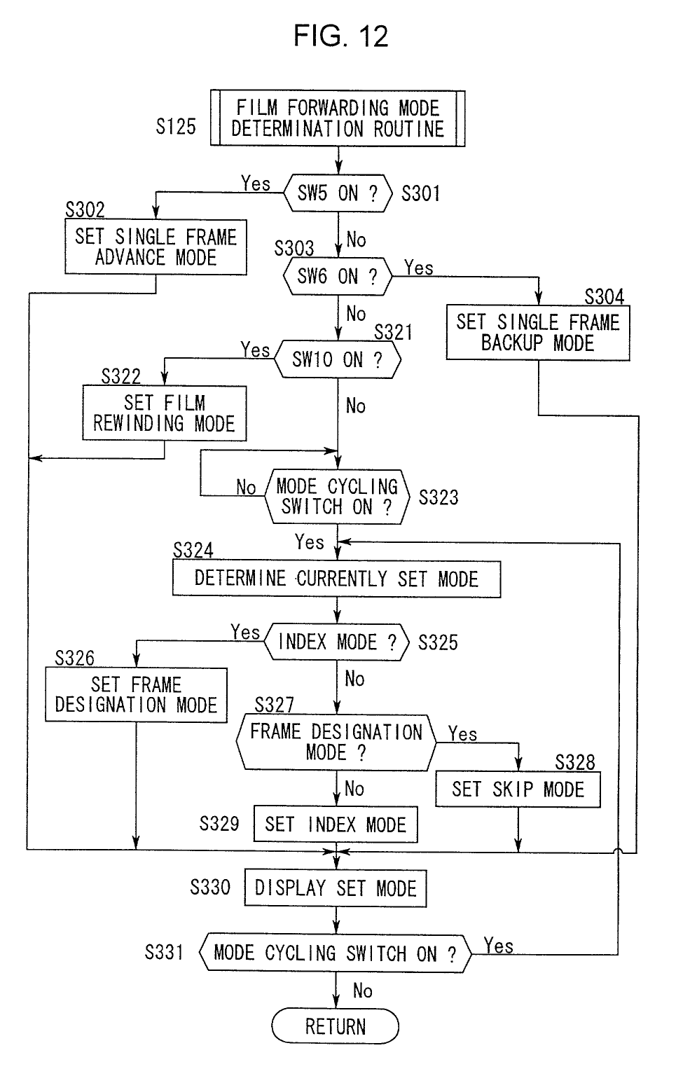

Moreover, although in this preferred embodiment it was so arranged that each of the film forwarding modes was set by the use of a single one of the individual dedicated switches SW5 through SW10 which were provided for this purpose, the actual operation for setting the film forwarding mode is not to be considered as being limited to this particular possibility. For example, as an alternative, while continuing to provide individual dedicated switches SW5, SW6, and SW10 for respectively setting the single frame advance mode, the single frame backup mode, and the film rewinding mode, it is possible to provide a single mode cycling switch for setting the index mode, the frame designation mode, and the skip mode, instead of the individual dedicated switches SW7, SW8, and SW9 described above. In this case, the set mode may be switched between the index mode, the frame designation mode, and the skip mode in a predetermined cycle, each time this single mode cycling switch is operated. FIG. 12 is a flow chart showing such a variant embodiment for this film forwarding mode determination processing routine.

Referring to this figure, in the first step S301 a decision is made as to whether or not the single frame advance switch SW5 is being operated, and when the single frame advance switch SW5 is indeed being operated then the flow of control proceeds to the step S302, in which the single frame advance mode is set. On the other hand, if in the step S301 it is decided that the single frame advance switch SW5 is not being operated, then the flow of control is transferred to the step S303, in which a decision is made as to whether or not the single frame backup switch SW6 is being operated, and when the single frame backup switch SW6 is indeed being operated then the flow of control proceeds to the step S304, in which the single frame backup mode is set. On the other hand, if in the step S303 it is decided that the single frame backup switch SW6 is not being operated, then the flow of control is transferred to the step S321, in which a decision is made as to whether or not the film rewinding switch SW10 is being operated, and when the film rewinding switch SW10 is indeed being operated then the flow of control proceeds to the step S322, in which the film rewinding mode is set. On the other hand, if in the step S321 it is decided that the film rewinding switch SW10 is not being operated, then the flow of control is transferred to the step S323, in which a decision is made as to whether or not a mode cycling switch not shown in the figures for changing over in a cycle between the index mode, the frame designation mode, and the skip mode is being operated, and if this mode cycling switch is not being operated then the flow of control loops back to this decision step S323 again, thus to wait until the mode cycling switch is indeed operated. When the mode cycling switch is operated, the flow of control proceeds to the step S324, in which it is determined which of the index mode, the frame designation mode, and the skip mode is set as the current film forwarding mode. The flow of control then proceeds to the step S325, in which a decision is made as to whether or not the currently set film forwarding mode is the index mode. If the currently set film forwarding mode indeed is the index mode, then the flow of control proceeds to the step S326, in which the film forwarding mode is changed over from this current index mode to the frame designation mode, while if not then the flow of control is transferred to the step S327. In this step S327, a decision is made as to whether or not the currently set film forwarding mode is the frame designation mode. If the currently set film forwarding mode indeed is the frame designation mode, then the flow of control proceeds to the step S328, in which the film forwarding mode is changed over from this current frame designation mode to the skip mode, while if not then the flow of control is transferred to the step S329. In this step S329, it is decided that logically the currently set film forwarding mode must be the skip mode, so that accordingly the film forwarding mode is changed over from this current skip mode to the index mode, and then the flow of control is transferred to the step S330, to which control is transferred after all the above mentioned steps S302, S304, S322, S326, and S328 as well. In this final step S330, the mode which has been set is displayed upon the video monitor 23. Next, in the step S331, a decision is made as to whether or not the mode cycling switch is operated. If the mode cycling switch is operated, then it is considered that the currently set film forwarding mode is not the one which is desired by the operator and that the operator therefore wishes to continue cycling through the three film forwarding modes which are available by this cycling process, and accordingly the flow of control returns back to the step S324, thus to repeat the above described cycling process, while if the mode cycling switch is not operated then the flow of control returns to the step S126 of the FIG. 7 flow chart.

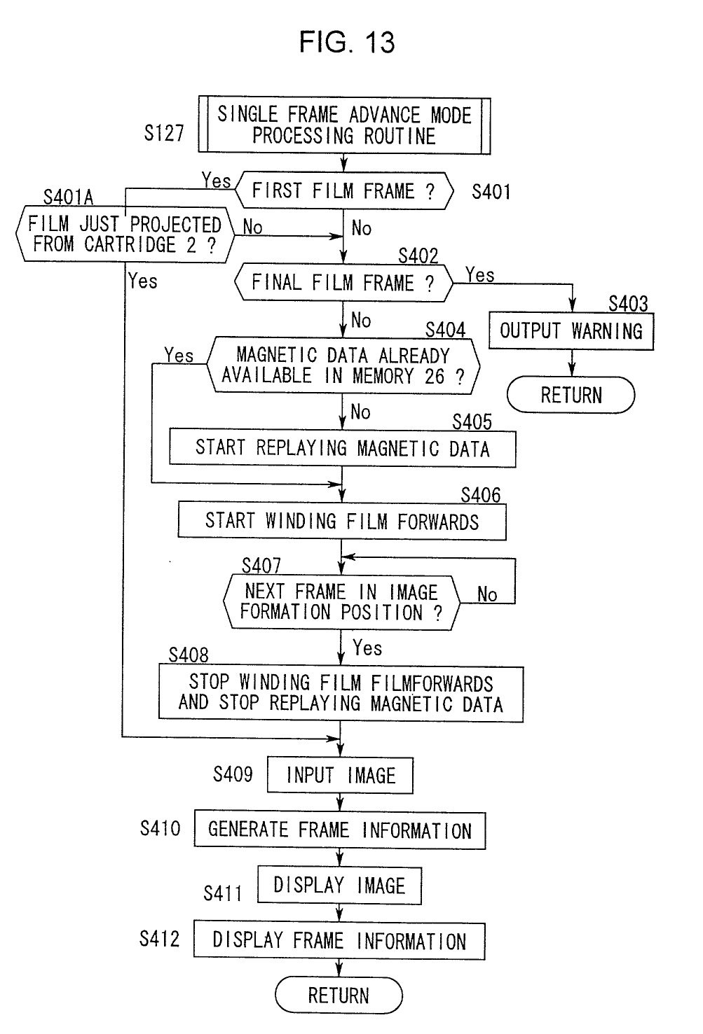

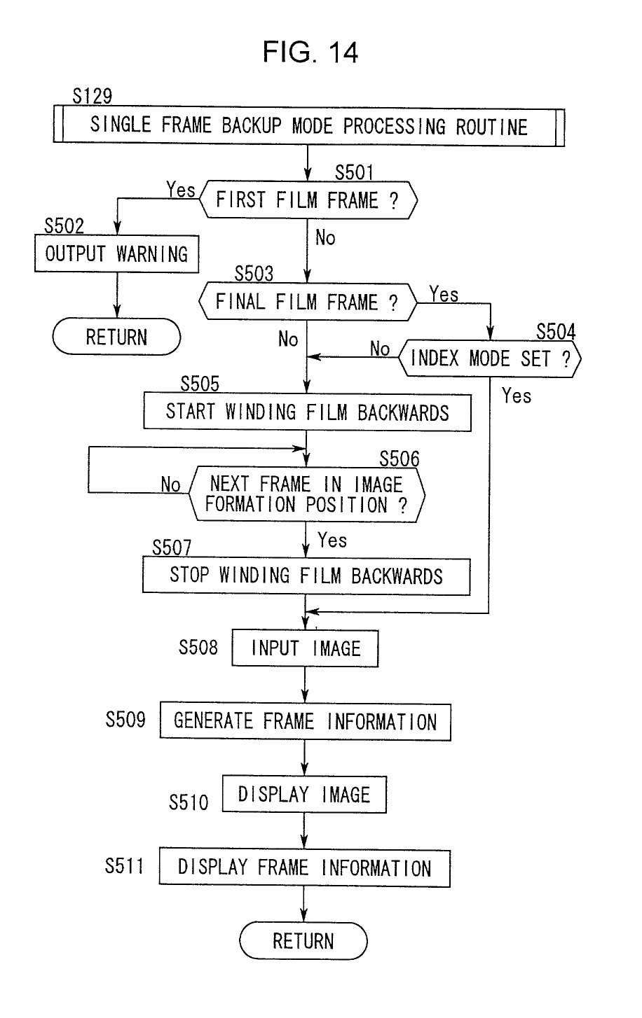

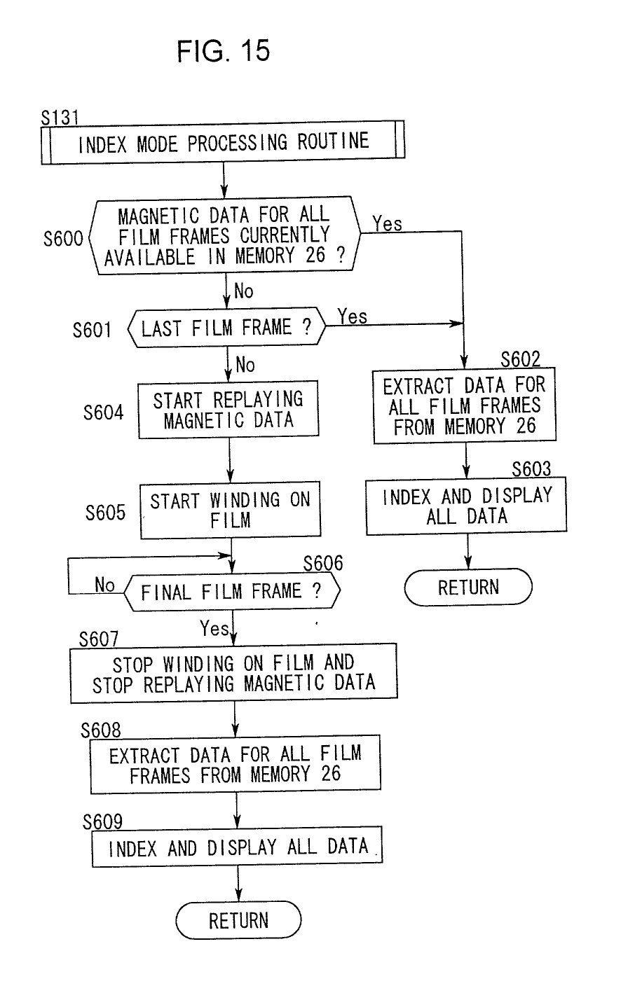

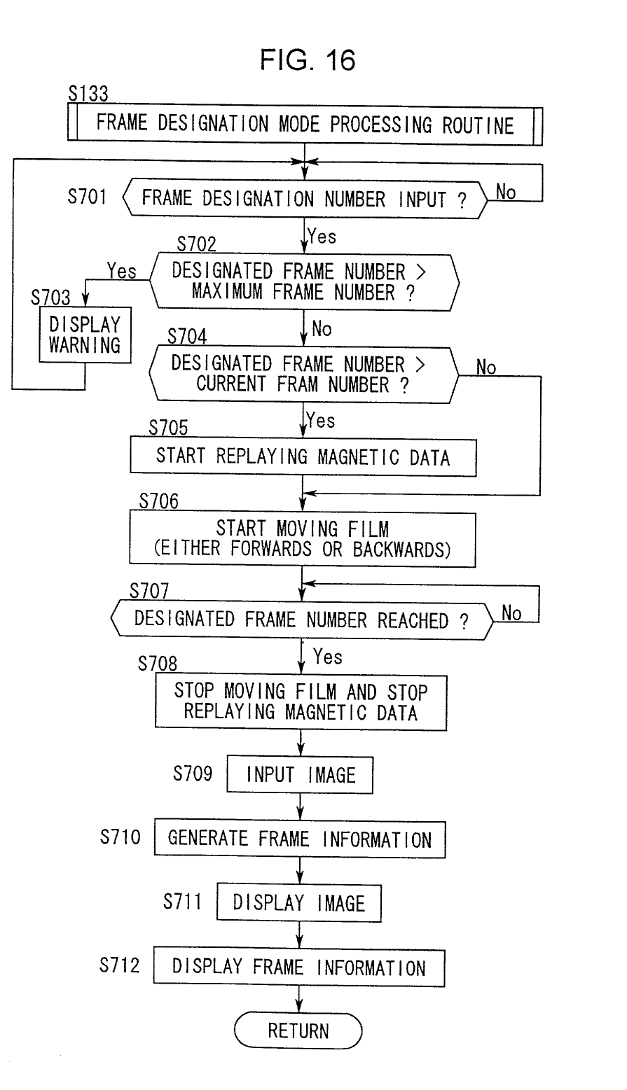

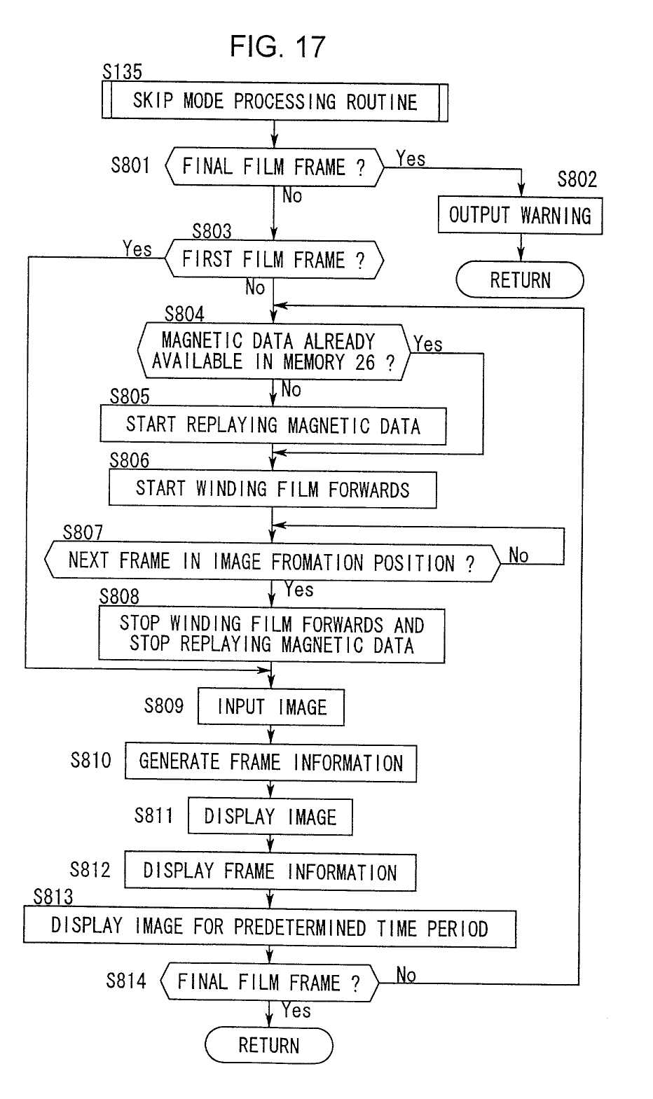

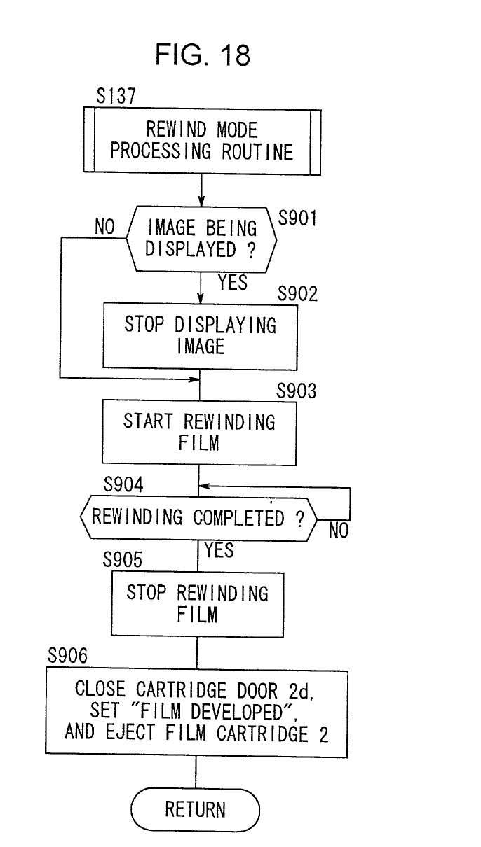

After returning, processing is performed in the steps S126 through S137 according to that one of the film forwarding modes which was set by the one actually employed of the two alternative forwarding mode determination routines described above and shown in FIGS. 11 and 12. In detail: if it is the single frame advance mode which has been set as the film forwarding mode, then the flow of control is transferred from the decision step S126 to the step S127, and a single frame advance mode processing routine whose flow chart is shown in FIG. 13 is executed; if it is the single frame backup mode which has been set as the film forwarding mode, then the flow of control is transferred from the decision step S128 to the step S129, and a single frame backup mode processing routine whose flow chart is shown in FIG. 14 is executed; and, if it is the index mode which has been set as the film forwarding mode, then the flow of control is transferred from the decision step S130 to the step S131, and an index mode processing routine whose flow chart is shown in FIG. 15 is executed. Moreover, if it is the frame designation mode which has been set as the film forwarding mode, then the flow of control is transferred from the decision step S132 to the step S133, and a frame designation mode processing routine whose flow chart is shown in FIG. 16 is executed; if it is the skip mode which has been set as the film forwarding mode, then the flow of control is transferred from the decision step S134 to the step S135, and a skip mode processing routine whose flow chart is shown in FIG. 17 is executed; and, if it is the film rewinding mode which has been set as the film forwarding mode, then the flow of control is transferred from the decision step S136 to the step S137, and an film rewinding mode processing routine whose flow chart is shown in FIG. 18 is executed. After the processing routine specified in the appropriate one of the steps S127, S129, S131, S133, S135, or S137 has been performed, or if none of all the above film forwarding modes is set, then the flow of control loops back to the step S104 of the FIG. 5 flow chart.

The operation for advancing the film by a single film frame will now be explained with reference to the single frame advance mode processing routine whose flow chart is shown in FIG. 13.

As described above, the film 3 is wound on by the appropriate amount to bring the first film frame to the image formation position directly after it is projected from the film cartridge 2. When from this state the film 3 is to be wound on by one frame, if the system merely starts winding the film 3 forward, then the second film frame will be brought to the image formation position without an image of the first film frame having been displayed. Accordingly, in this preferred embodiment of the present invention, when the operation of advancing the film by one frame is to be performed with the first film frame set to the image formation position, first the image on the first film frame is input and is displayed.

Further, if the film 3 is wound on by one frame from the state in which the final frame upon the film is positioned to the image formation position, then the film 3 will be advanced to a position in which a portion thereof upon which no image is available to be displayed will be brought to the image formation position, which will likely cause the operator of this film image signal generation apparatus to lose his bearings. Accordingly, in this preferred embodiment of the present invention, when the operation of advancing the film by one frame is commanded with the final film frame set to the image formation position, the advancement of the film is prohibited, and a warning is issued.

Further, there is a danger that the film 3 may be damaged if the magnetic head MH1 for playback is always kept in contact with the magnetic recording region 3b on the film 3 when the film is to be advanced by one frame. Accordingly, in this preferred embodiment of the present invention, before performing the action of advancing the film by one film frame, a check is made as to whether or not the magnetic data for the next film frame has already been replayed and is currently stored in the memory 26, and if the data for the next film frame is already available in the memory 26 the magnetic head MH1 for playback is removed away from contact with the film 3 before the film is advanced, so that no unnecessary replaying of magnetic data is uselessly performed, whereby wear and tear of the film 3 is minimized.

In the first step S401, a decision is made as to whether or not the film 3 is in its position with the first film frame set to the image formation position. If in fact the first film frame is currently set to the image formation position, then the flow of control proceeds to the step S401A, in which it is checked whether or not the film 3 has just been projected from the film cartridge, i.e. whether or not the current state is the state directly after the initial forwarding of the film. If in fact this is the state directly after initial film forwarding, then the flow of control skips to the step S409, while if not then the flow of control is transferred to the step S402. Usually when the film has been projected from the cartridge 2 after the cartridge 2 has been loaded the first film frame is set to the image formation position as described above. Since in this case display of the image of the first frame has not been performed when the film is to be advanced by one frame, in this case forwarding by one film frame is not performed, but instead first display of the image of the first film frame is performed.

If the film 3 is not positioned with the first film frame set to the image formation position, then in the step S402 a decision is made as to whether or not the final film frame is set to the image formation position, and if the final film frame is set to the image formation position then the flow of control proceeds to the step S403, while if not then the flow of control is transferred to the step S404. Since some magnetic data have been recorded at the location of a film frame which has actually been shot, it would be acceptable to consider the film frame which has the maximum frame number upon which magnetic data is recorded as being the final film frame.

When the single frame advance switch SW5 is operated without any regard for the fact that it is the final film frame which is set to the image formation position, then, without advancing the film by one frame, in the step S403 a warning message such as “Further advance not possible because this is the final film frame” is displayed upon the video monitor 23, and an audible warning is emitted via the buzzer Bz, and then the flow of control returns to the step S104 of the FIG. 5 main routine flow chart.

As explained above, in this preferred embodiment, in the single frame advance mode, when an attempt is made to advance the film by one further frame with the final film frame already set to the image formation position, then a warning is emitted and also further advancement of the film is prohibited, and accordingly it can never happen that the film comes to be advanced so far as to attempt to display a frame from a portion thereof upon which in fact no frame is present to be displayed, and accordingly the operability of this film image signal generation apparatus is improved.

Moreover, even if a fast frame forward mode were to be provided, in the same manner it would be possible, if an attempt were made to advance the film further forward from the position thereof in which the final film frame was already set to the image formation position, to prohibit such further advancement of the film and to emit a warning.

Further, since an image of the first film frame is input and is displayed when an attempt is made to advance the film by one frame with the first film frame positioned at the image formation position directly after initial film forwarding, while the film is simply advanced as requested when an attempt is made to advance the film by one frame with a film frame other than the first film frame positioned at the image formation position, thereby it is possible to display images starting from and including the first film frame, even when the single frame advance mode is set and when the first film frame is positioned at the image formation position directly after initial film forwarding. In particular, even when the single frame advance mode is set after the film has been projected from the film cartridge, it is possible to display the images upon the film in order, starting from and including the first film frame.

When the frame which is positioned at the image formation position is neither the first film frame nor the final film frame, then the film is advanced by one film frame. First, in the step S404, a decision is made as to whether or not the magnetic data for the next film frame has already been replayed so as to be currently available in the memory 26. If this magnetic data for the next film frame is already available in the memory 26, then the flow of control skips to the step S406 since there is no need to replay the magnetic data from the film 3 again, while if the magnetic data for the next film frame is not currently available in the memory 26 then the flow of control continues to the step S405, in which the magnetic head MH1 for playback is brought into contact with the film 3 and replay operation for the magnetic data upon the film 3 by the replay circuit 24 is commenced.

In this manner, when the magnetic data for the next film frame has already been replayed so that it is already available in the memory 26, then the magnetic head MH1 for playback is kept in its withdrawn position out of contact with the film 3 and the operation of replaying the information (again, unnecessarily) is not performed, so that wear and tear upon the film 3 is not unnecessarily generated, and abrasion of the magnetic head MH1 for playback is also abated.

In the next step S406 the driver DR3 is operated so as to start the spool drive motor M3 and the action of advancing the film 3 is started, and in the next step S407 a decision is made based upon the result of perforation detection as performed by the photointerruptors PH1 and PH2 as to whether or not the next film frame has yet arrived at the image formation position. If the next film frame has not yet arrived at the image formation position the flow of control loops back to this decision step S407 again, thus to continue waiting until in fact the next film frame does arrive at the image formation position, at which point the flow of control proceeds to the next step S408, in which the spool drive motor M3 is stopped so as to stop advancing the film 3, and also the magnetic head MH1 for playback is withdrawn from contact with the film 3 and the operation of the replay circuit 24 for replaying magnetic data from the film 3 is terminated.

In the next step S409 an image of the film frame, which is now at the imaging position, is input via the CCD 9 and the image formation circuit 21. In the next step S410 the data stored in the memory 26 which corresponds to the magnetic data upon the film 3 relating to this film frame is extracted and frame information is generated based thereupon; next in the step S411 the film frame image is displayed upon the video monitor 23; and finally in the step S412 the frame information for this film frame which was generated in the step S410 is displayed upon the video monitor 23. This magnetically recorded data relating to the current film frame may typically include photographic information such as photographic conditions relating to this film frame, reference information which is input according to the requirements of the photographer, and the like.

The operation for backing up the film by a single film frame will now be explained with reference to the single frame backup mode processing routine whose flow chart is shown in FIG. 14.

If the film 3 is wound back by a single film frame from the state in which the first frame upon the film is already positioned to the image formation position, then the film 3 will (undesirably) be rewound to a position in which a portion thereof upon which no image is available to be displayed will be brought to the image formation position, which will likely cause the operator of this film image signal generation apparatus to lose his bearings. Accordingly, in this preferred embodiment of the present invention, when the operation of backing up the film by one frame is commanded with the first film frame set to the image formation position, the backing up of the film is prohibited, and a warning is issued.

Further, if the index mode is set, the film 3 is advanced all the way and then the final film frame will be brought to the image formation position. When from this state the film 3 is to be backed up by one frame, if the system merely starts winding the film 3 backward, then the next to final film frame will be brought to the image formation position without an image of the final film frame having been displayed. Accordingly, in this preferred embodiment of the present invention, when the final film frame is set to the image formation position, and the operation of backing up the film by one frame is to be performed, a check is made as to whether or not the index mode is set, and if the index mode is indeed set the backing up of the film by one frame is prohibited, and instead the image on the final film frame is input and is displayed. However, if the index mode is not set, the operation of backing up the film by one frame is performed.

In the first step S501, a decision is made as to whether or not the film 3 is in its position with the first film frame set to the image formation position. If in fact the first film frame is currently set to the image formation position, then the flow of control proceeds to the step S502, while if not then the flow of control is transferred to the step S503.

When the single frame backup switch SW6 is operated without any regard for the fact that it is the first film frame which is set to the image formation position, then, without backing up the film by one frame, in the step S502 a warning message such as “Further backup not possible because this is the first film frame” is displayed upon the video monitor 23, and an audible warning is emitted via the buzzer Bz, and then the flow of control returns to the step S104 of the FIG. 5 main routine flow chart.

In this manner, when an attempt is made to back up the film by one further frame with the first film frame already set to the image formation position, then a warning is emitted and also further backing up of the film is prohibited, and accordingly it can never happen that the film comes to be backed up so far as to attempt to display a frame from a portion thereof upon which in fact no frame is present to be displayed, and accordingly the operability of this film image signal generation apparatus is improved.

Moreover, even if a fast frame backward mode were to be provided, in the same manner it would be possible, if an attempt were made to back up the film further backward from the position thereof in which the first film frame was already set to the image formation position, to prohibit such further backing up of the film and to emit a warning.

When the frame which is positioned at the image formation position is not the first film frame, then in the step S503 a decision is made as to whether or not the frame which is positioned at the image formation position is the final film frame. If in fact the frame which is positioned at the image formation position is the final film frame, then the flow of control proceeds to the step S504, while if not then the flow of control proceeds to the step S505. Moreover, since some magnetic data have been recorded at the location of a film frame which has actually been shot, it would be acceptable to consider the film frame which has the maximum frame number upon which magnetic data is recorded as being the final film frame.

When the frame which is positioned at the image formation position is the final film frame, in the step S504 a decision is made as to whether or not the index mode is currently set, and if the index mode is currently set then the flow of control skips to the step S508, while if the index mode is not currently set then the flow of control proceeds to the step S505. When backing up of the film by one film frame is commanded in the case that the final film frame has been brought to the image formation position by the film being forwarded in the index mode, then since no image of this final film frame has as yet been displayed the film is not backed up by one frame, but instead an image of the final film frame is input and is displayed.

Since in this manner an image of the final film frame is input and is displayed when backing up of the film by one film frame is commanded in the case that the final film frame is in the image formation position, while on the other hand the film is backed up by one frame when backing up of the film by one film frame is commanded in the case that the final film frame is not in the image formation position, thereby it is possible to display the film frames in order from the final film frame when the final film frame is in the image formation position, even when the single frame backup mode is set. In particular, even when the single frame backup mode is set after in the index mode the film has been advanced to its end state in which the final film frame is positioned at the image formation position, it is possible to display the film frames in order from the final film frame.

If the frame which is positioned at the image formation position is not the final film frame, or if the index mode is not set, then the film is backed up by one frame. Thus, in the next step S505 the driver DR1 is operated so as to start the film forwarding/rewinding motor M1 and the action of backing up the film 3 is started, and in the next step S506 a decision is made based upon the result of perforation detection as performed by the photointerruptors PH1 and PH2 as to whether or not the next film frame has yet arrived at the image formation position. If the next film frame has not yet arrived at the image formation position the flow of control loops back to this decision step S506 again, thus to continue waiting until in fact the next film frame does arrive at the image formation position, at which point the flow of control proceeds to the next step S507, in which the film forwarding/rewinding motor M1 is stopped so as to stop backing up the film 3, so that the action of backing up the film 3 by one film frame is now complete.

In the next step S508 an image of the film frame, which is now at the imaging position, is input via the CCD 9 and the image formation circuit 21. In the next step S509 the data stored in the memory 26 which corresponds to the magnetic data upon the film 3 relating to this film frame is extracted and frame information is generated based thereupon; next in the step S510 the film frame image is displayed upon the video monitor 23; and finally in the step S511 the frame information for this film frame which was generated in the step S509 is displayed upon the video monitor 23. This magnetically recorded data relating to the current film frame may typically include photographic information such as photographic conditions relating to this film frame, reference information which is input according to the requirements of the photographer, and the like.

The operation for index mode processing will now be explained with reference to the index mode processing routine whose flow chart is shown in FIG. 15.

As described above, by the index mode is meant a mode in which first the information for all of the film frames is read out and is displayed, and this mode is provided in order for the operator to be able to select which film frames he wishes to display upon the video monitor 23 while inspecting the displayed index information for all of the frames upon the currently loaded film.

Normally the index mode will be set when directly after the film has been projected from the film cartridge after loading thereof the first film frame is positioned at the image formation position, but in principle in this preferred embodiment of the present invention it is possible to set the index mode at any stage, whichever film frame is currently positioned at the image formation position. Further, if the index mode is set when the final film frame is positioned at the image formation position, since the magnetic information for all of the film frames at this stage have been replayed and stored in the memory 26, it may be displayed immediately. Since some magnetic data have been recorded at the location of a film frame which has actually been shot, it would be acceptable to consider the film frame which has the maximum frame number upon which magnetic data is recorded as being the final film frame.

In the first step S600 of this index mode processing routine, a decision is made as to whether or not the magnetic information for all of the frames upon the film 3 of the film cartridge 2 which is currently loaded is already currently available in the memory 26. If the information for all of the film frames is already available, then the flow of control is transferred to the step S602, while if not then the flow of control proceeds to the step S601. By performing this check, unnecessary forwarding of the film 3 and reading out of magnetic information thereupon are avoided.

In the step S601, a decision is made as to whether or not the specified final frame upon the film 3 is currently positioned at the image formation position, and if the final frame upon the film 3 is indeed currently positioned at the image formation position then the flow of control proceeds to the step S602, while if not then the flow of control is transferred to the step S604. Since when the final frame upon the film 3 is positioned at the image formation position this implies that the magnetic data for all of the frames upon the film 3, from the first frame to the final frame thereof, must necessarily have been replayed and stored in the memory 26 during the process of forwarding the film onward to this final film frame, therefore in the step S602 the magnetically recorded data for all of the film frames is extracted from the memory 26, and in the next step S603 all of this data is indexed and is displayed upon the video monitor 23. After this, the flow of control returns to the step S104 of the FIG. 5 main routine, in order to wait for the operator to issue the next film forwarding instruction.

If the film frame which currently is in the image formation position is not the final film frame, although the magnetic data for the series of film frames from the first film frame to this current film frame already have been stored in the memory 26 and thus are available, since presumably the magnetic data for the series of film frames from this current film frame to the final film frame not yet have been replayed and thus presumably not be available, therefore the film is wound on as far as the final film frame thereof while replaying the magnetic data for the series of film frames from this current film frame to the final film frame and storing this data in the memory 26. Accordingly in the step S604 the magnetic head MH1 for playback is brought into contact with the film 3 and replaying of the magnetic data thereof by the replay circuit 24 and storing this data in the memory 26 are started, and in the next step S605 the driver DR3 and the spool drive motor M3 are operated so as to start winding the film 3 forwards. In the next step S606 a decision is made based upon the results of perforation detection performed by the photointerruptors PH1 and PH2 as to whether or not the film 3 has reached its final position where the specified final film frame is in the image formation position, and if not then the flow of control loops back to this decision step S606 again, thus to wait for the film 3 to arrive at its final position. Since some magnetic data have been recorded at the location of a film frame which has actually been shot, it would be acceptable to consider the film frame which has the maximum frame number upon which magnetic data is recorded as being the final film frame. On the other hand, when the film 3 reaches its final position where the specified final film frame is in the image formation position, then the flow of control proceeds to the step S607, in which the spool drive motor M3 is stopped so as to stop winding on the film 3, and the magnetic head MH1 for playback is removed away from the film 3 and replaying of the magnetic data therefrom by the replay circuit 24 is terminated. And in the next step S608 the magnetically recorded data for all of the film frames is extracted from the memory 26, and in the next step S609 all of this data is indexed and is displayed upon the video monitor 23. After this, the flow of control returns to the step S104 of the FIG. 5 main routine in order to wait for the operator to issue the next film forwarding instruction.

Since as explained above with this preferred embodiment of the present invention, in the index mode, the magnetic data recorded upon the film 3 for all of the film frames from the current film frame to the final film frame is replayed from the film 3 while it is wound on as far as the final film frame thereof and is stored in the memory 26, and then the replayed information for all of the frames upon the film 3 is displayed, therefore it is possible for the operator to know what photographs have been shot upon this film 3 before displaying any of the images thereof, and it is possible for him to bring any film frame of which he wishes to display an image to the image formation position so as directly to view an image thereof, etc., whereby the operability during film forwarding and viewing is enhanced.

Further, since the magnetically recorded information for the various film frames is replayed while the film 3 is being advanced as far as the final film frame thereof, and the information for these various film frames which has been replayed is stored in the memory 26, therefore it is possible at any time thereafter to display the index information for all of the frames upon the film 3.

Yet further, since in the index mode the magnetic data recorded upon the film 3 for all of the film frames from the first film frame to the current film frame has already been replayed and thus is already available and is stored in the memory 26, therefore it is only necessary to contact the magnetic head MH1 for playback against the film 3 and replay magnetic data therefrom for the film frames from this current film frame to the final frame upon the film 3, in order to store this information in the memory 26. Accordingly unnecessary forwarding of the film 3 and unnecessary reading out of magnetic information thereupon, and the consequent unnecessary wear and tear upon the film 3, are avoided, and unnecessary abrasion of the magnetic head MH1 for playback is also avoided.

And, if the film frame which has the maximum frame number upon which magnetic data is recorded was considered as the final film frame in the index mode, the operation of forwarding the film and replaying the magnetically recorded data up to the unexposed final frame would not be needed.

Moreover, it would also be possible to arrange matters so that, in the case of the index mode being set when the apparatus was in its state with an intermediate film frame being positioned at the image formation position, the operation of replaying the magnetically recorded information for subsequent film frames between this current film frame and the final film frame was eliminated, if this information was already available in the memory 26.

Further, although in this shown preferred embodiment of the present invention, in the index mode, the data for all of the film frames of the currently loaded film cartridge was obtained and was stored in the memory 26, and then was displayed upon the video monitor 23 as a whole, as an alternative it would also be possible to display this information during the process of gathering it, bit by bit as it became available. In this case, the additional function would be available of being able to stop the index mode operation part way through, before the completion thereof.

The operation for frame designation mode processing will now be explained with reference to the frame designation mode processing routine whose flow chart is shown in FIG. 16.

As described above, the frame designation mode is a mode in which an image of any film frame the number of which is designated by the operator is displayed. In this preferred embodiment of the present invention, when the operator designates a frame number which is greater than the maximum frame number on the film 3, the system emits an alarm. Furthermore; although when the designated film frame number is greater than the number of the film frame which is currently at the image formation position replaying and storage in the memory 26 of the magnetic data recorded upon the film 3 is performed as the film is wound on forwards from the current film frame to the designated film frame, by contrast when the designated film frame number is smaller than the number of the film frame which is currently at the image formation position replaying and storage of the magnetic data recorded upon the film 3 is not performed as the film is wound backwards from the current film frame to the designated film frame, since the magnetic data from the first film frame to the film frame which is currently in the image formation position must already have been completely replayed and stored in the memory 26 when the film was previously wound forward to the current position thereof after it was initially loaded. Since some magnetic data have been recorded at the location of a film frame which has actually been shot, therefore, by considering the maximum frame number in the frame designation mode as the frame number of the highest frame which has actually been shot, the operation of winding the film forward and replaying the magnetic data up to the unexposed last frame is not needed.

In the step S701 of the FIG. 16 flow chart, the system loops until the number of a frame to be designated is input via the numerical input device 27. In the next step S702, a decision is made as to whether or not the input designated frame number is greater than the specified maximum frame number upon the film 3, and if it is greater then the flow of control proceeds to the step S703, while if not then the flow of control is transferred to the step S704. Moreover, as described above, it would also be acceptable to consider the number of the last film frame upon which magnetic data is recorded as being the maximum film frame number. If a frame number is designated which is greater than the maximum frame number, then in the step S703 a warning message such as “Designated frame number exceeds maximum frame number upon film” is displayed upon the video monitor 23, and a warning sound is emitted via the buzzer Bz.

However, when the frame number which is designated is less than or equal to the maximum frame number, then in the step S704 a decision is made as to whether or not this designated frame number is greater than the number of the frame which currently is in the image formation position, and if the designated frame number is greater than the current frame number then the flow of control continues to the step S705, in which the magnetic head MH1 for playback is brought into contact with the film 3 and replay operation for the magnetic data upon the film 3 by the replay circuit 24 is commenced, and also the storage of this replayed magnetic data in the memory 26 is started. The flow of control then continues to the step S706, to which control flow also skips from the decision step S704 in the event that the designated frame number is less than or equal to the current frame number, since in this case the magnetic information for all the film frames up to the current film frame has already been replayed and hence is already stored in the memory 26, so that there is no need to replay it again. In the step S706, when the designated frame number is greater than the number of the film frame which is currently at the image formation position, the driver DR3 and the spool drive motor M3 are operated so as to start winding the film 3 forwards, while on the other hand, when the designated frame number is less than the number of the film frame which is currently at the image formation position, the driver DR1 and the film forwarding/rewinding motor M1 are operated so as to start winding the film 3 backwards.

In the next step S707, a decision is made based upon the results of perforation detection performed by the photointerruptors PH1 and PH2 as to whether or not the film 3 has reached its proper position where the designated film frame is in the image formation position, and if not then the flow of control loops back to this decision step S707 again, thus to wait for the film 3 to arrive at its proper position. On the other hand, when the film 3 reaches its proper position where the designated final film frame is in the image formation position, then the flow of control proceeds to the step S708, in which the relevant driver and motor are stopped so as to stop moving the film 3, and the magnetic head MH1 for playback is removed away from the film 3 and replaying of the magnetic data therefrom by the replay circuit 24 is terminated.

Since in this manner, in the frame designation mode, the magnetic data from the first film frame to the film frame which currently is positioned at the image formation position has already been replayed and is already stored in the memory 26, accordingly the magnetic head MH1 for playback is only brought into contact with the film 3 so as to perform replaying of the information which is magnetically recorded thereupon when the number of the designated film frame is greater than the number of the film frame which currently is positioned at the image formation position, i.e. when the film is to be wound forwards. Accordingly unnecessary forwarding of the film 3 and unnecessary reading out of magnetic information thereupon, and the consequent unnecessary wear and tear upon the film 3, are avoided, and unnecessary abrasion of the magnetic head MH1 for playback is also avoided.

In the next step S709 an image of the designated film frame, which is now at the imaging position, is input via the CCD 9 and the image formation circuit 21. In the next step S710 the data stored in the memory 26 which corresponds to the magnetic data upon the film 3 relating to this designated film frame is extracted and frame information is generated by the image control circuit 22 based thereupon; next in the step S711 the film frame image is displayed upon the video monitor 23; and finally in the step S712 the frame information for this film frame which was generated in the step S710 is displayed upon the video monitor 23. This magnetically recorded data relating to the current film frame may typically include photographic information such as photographic conditions relating to this film frame, reference information which is input according to the requirements of the photographer, and the like.

As explained above, in the film image signal generation apparatus of this preferred embodiment, the film frame whose number is specified by the use of the numerical input device 27 is brought to the image formation position so that an image thereof may be displayed; and accordingly, if the operator already knows the contents of the image of each frame upon a film, it is possible for him immediately to display the image of any film frame which he desires to inspect.

Further, since a warning is emitted if the frame number which is designated by the use of the numerical input device 27 exceeds the maximum frame number upon the currently loaded film 3, thereby it is possible for the operator immediately to be apprised of the fact that he has made a mistake in operation, and accordingly he can immediately rectify his error and input an appropriate frame number. Accordingly, it is possible to improve the operability of this film image signal generation apparatus.

The operation for skip mode processing will now be explained with reference to the skip mode processing routine whose flow chart is shown in FIG. 17. As described above, by the skip mode is meant a mode in which the film frames are displayed one at a time in sequence, each for a predetermined interval. Since in this preferred embodiment of the present invention the skip mode is executed while the film 3 is being wound forwards, accordingly a warning is issued if the skip mode is set when the final frame upon the film 3 is positioned at the image formation position.

Furthermore, when the skip mode is set directly after the film 3 has been projected out from the film cartridge 2 so that the first film frame is positioned at the image formation position, first an image of the first film frame is input and is displayed.

In the first step S801, a decision is made as to whether or not the final film frame is set to the image formation position, and if the final film frame is set to the image formation position then the flow of control proceeds to the step S802, in which a warning message such as “Image display in skip mode not possible because this is the final film frame” is displayed upon the video monitor 23, and an audible warning is emitted via the buzzer Bz, and then the flow of control returns to the step S104 of the FIG. 5 main routine flow chart in order to wait for the operator to issue the next film forwarding command. Moreover, at this time, it would also be an alternative possibility to perform temporary rewinding of the film 3 in a fast rewind mode as far as the first film frame, and then to perform image display in the skip mode from the first film frame onwards. Since magnetic data have been recorded at the location of a film frame which has actually been shot, it would be acceptable to take the film frame which has the maximum frame number upon which magnetic data is recorded as being the final film frame.

If it is not the final film frame which is set to the image formation position, then the flow of control is transferred to the step S803, in which a decision is made as to whether or not the first film frame is set to the image formation position. Although directly after the film has been projected from the cartridge 2 after the cartridge 2 has been loaded the first film frame is set to the image formation position, since in this case display of the image of the first frame has not been performed, accordingly in this case forwarding of the film by one film frame is not performed, but instead the flow of control is transferred to the step S809 and the subsequent steps, so that first the image of the first film frame is input and is displayed. If, however, the frame which is positioned at the image formation position is neither the first film frame nor the final film frame, then in the step S804 a decision is made as to whether or not the magnetic data for the next film frame has already been replayed so as to be currently available in the memory 26. If this magnetic data for the next film frame is already available in the memory 26, then the flow of control skips to the step S806 since there is no need to replay the magnetic data from the film 3 again, while if the magnetic data for the next film frame is not currently available in the memory 26 then the flow of control continues to the step S805, in which the magnetic head MH1 for playback is brought into contact with the film 3 and replay operation for the magnetic data upon the film 3 by the replay circuit 24, and storage thereof in the memory 26, are commenced. And in the next step S806 the driver DR3 is operated so as to start the spool drive motor M3 and the action of advancing the film 3 is started.

Further, since as explained above in this preferred embodiment of the present invention an image of the first film frame is input and is displayed when the skip mode is set with the first film frame positioned at the image formation position, while when the skip mode is set with a film frame other than the first film frame positioned at the image formation position the film is advanced by one frame, thereby it is possible to display images starting from and including the first film frame, even when the skip mode is set with the first film frame being positioned at the image formation position. In particular, even when the skip mode is set after the film has been projected from the film cartridge, it is possible to display the images upon the film in order, starting from and including the first film frame.

Further, since the magnetic head MH1 for playback is brought into contact with the film 3 and the operation of replaying the information magnetically recorded thereupon is performed only when this magnetic data for the next film frame has not yet been replayed and is not yet available in the memory 26, i.e. only when necessary, thereby wear and tear upon the film 3 is not unnecessarily generated, and abrasion of the magnetic head MH1 for playback is also abated.

In the next step S807 a decision is made based upon the result of perforation detection as performed by the photointerruptors PH1 and PH2 as to whether or not the next film frame has yet arrived at the image formation position. If the next film frame has not yet arrived at the image formation position the flow of control loops back to this decision step S807 again, thus to continue waiting until in fact the next film frame does arrive at the image formation position, at which point the flow of control proceeds to the next step S808, in which the operation of the driver DR3 and of the spool drive motor M3 is stopped so as to stop advancing the film 3, and also the magnetic head MH1 for playback is withdrawn from contact with the film 3 and the operation of the replay circuit 24 for replaying magnetic data from the film 3 is terminated.

In the next step S809 an image of the next film frame, which is now at the imaging position, is input via the CCD 9 and the image formation circuit 21. In the next step S810 the data stored in the memory 26 which corresponds to the magnetic data upon the film 3 relating to this film frame is extracted and frame information is generated by the image control circuit 22 based thereupon; next in the step S811 the film frame image is displayed upon the video monitor 23; and then in the step S812 the frame information for this film frame which was generated in the step S810 is displayed upon the video monitor 23. This magnetically recorded data relating to the current film frame may typically include photographic information such as photographic conditions relating to this film frame, reference information which is input according to the requirements of the photographer, and the like. Next in the step S813 the system waits for a predetermined time period while displaying the image of the current film frame, and then in the next step S814 a decision is made as to whether or not the film frame of which the image is currently being displayed is the final film frame. If in fact currently the final film frame is set to the image formation position, then the flow of control returns to the step S104 of the FIG. 5 main routine flow chart in order to wait for the operator to issue the next film forwarding command, while if this current film frame is not the final one then the flow of control returns back to the step S804, and the above described process is repeated until the final film frame is arrived at. At this time, since some magnetic data have been recorded at the location of a film frame which has actually been shot, it would be acceptable to take the film frame which has the maximum frame number upon which magnetic data is recorded as being the final film frame.

Moreover, it would also be acceptable as an alternative to perform image display in the skip mode while the film 3 was being rewound back into the film cartridge 2. Further, it would also be possible to add a function whereby image display in the skip mode could be stopped when only partially completed.

The operation for film rewinding mode processing will now be explained with reference to the film rewinding mode processing routine whose flow chart is shown in FIG. 18.

In the step S901, a decision is made as to whether or not the image of any film frame is currently being displayed upon the video monitor 23. If some frame image is being displayed, then the flow of control proceeds to the step S902, in which the display of this image is terminated, while if not this step S902 is skipped. In the next step S903, the rewinding of the film 3 into the film cartridge 2 by the operation of the driver DR1 and the film forwarding/rewinding motor M1 is started, and in the next step S904 a decision is made based upon the result of perforation detection as performed by the photointerruptors PH1 and PH2 as to whether or not the film 3 has been completely wound back into the film cartridge 2. When the rewinding of the film 3 is completed, the flow of control proceeds to the next step S905, in which the film forwarding/rewinding motor M1 is stopped so as to stop rewinding the film 3. Next, in the step S906, the cartridge door 2d is closed by the operation of the driver DR2 and the cartridge door opening/closing motor M2, the indicator mechanism 2c of the film cartridge 2 is set to “film developed” by an actuator not shown in the figures, and the film cartridge 2 is ejected from the cartridge chamber by the eject mechanism (not shown). Thereafter, the flow of control returns to the step S104 of the FIG. 5 flow chart.

A Variant Embodiment

In the above described preferred embodiment of the present invention, it was shown by way of example that, so as to make it possible to select the forwarding mode for the film 3 which was loaded after checking the contents of the film 3, the magnetically and/or optically recorded information other than the image itself on the leader portion of the film 3 or upon the first frame thereof was replayed along with the initial forwarding for projecting the film 3 out of the film cartridge 2 until the first film frame arrived at the image formation position, and then it was possible to display this replayed information other than the image itself upon the leader portion of the film 3 or upon the first frame thereof so that the contents of the film could be checked, without at this time displaying an image of the first film frame which was positioned at the image formation position.

However, information which is recorded on the leader portion of the film 3 can be made available even without the film 3 being initially forwarded out of the film cartridge 2 to the point at which the first film frame is positioned at the image formation position; it is sufficient only to forward the film 3 to the point at which the so called zeroth film frame is positioned at the image formation position. Herein, by the zeroth film frame is meant a hypothetical film frame next to the first film frame in the direction of the leader portion of the film 3.

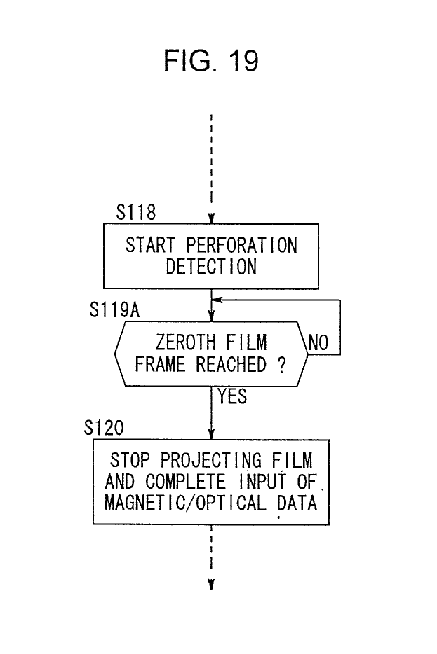

In this connection, referring to FIG. 19, a variant of the above described preferred embodiment of the present invention will be described in which the information which is recorded upon the leader portion of the film is read out while the film is being initially forwarded until the zeroth film frame reaches the image formation position. Moreover, since this variant embodiment only differs from the preferred embodiment described above in a certain portion of the FIG. 6 flow chart for its main processing routine, the explanation herein will chiefly focus upon the points by which these embodiments differ.

The detection of the perforations in the film 3 starts in the step S118 from when the projection of the film 3 from the film cartridge 2 has started, and in the next step S119A a decision is made based upon the result of perforation detection as performed by the photointerruptors PH1 and PH2 as to whether or not the zeroth film frame has yet arrived at the image formation position. If the zeroth film frame has not yet arrived at the image formation position the flow of control loops back to this decision step S119A again, thus to continue waiting until in fact the zeroth film frame does arrive at the image formation position, at which point the flow of control proceeds to the next step S120, in which, along with stopping the further projection of the film 3 out of the film cartridge 2, the input of magnetic data and/or of optical data is completed. After this, the processing of the magnetic and/or optical data is performed in a manner identical to that in the preferred embodiment described above, and the information which has been thus read in from the leader portion of the film 3 is displayed upon the video monitor 23.

Since in this manner the magnetically and/or optically recorded information other than an image on the leader portion of the film 3 is replayed and is displayed along with forwarding the film 3 out from the film cartridge 2 so as to bring a portion of the film one frame towards the film leader from the first film frame to the image formation position, therefore the information relating to the contents of the film in a film cartridge which is loaded can be displayed before selection of a forwarding mode for the film, and accordingly a film forwarding mode suitable for the contents of the film can be quickly and easily selected.

Another Variant Embodiment

However, when a film which has no information recorded upon its leader portion is loaded and is initially forwarded, if this film is stopped with its zeroth film frame positioned at the imaging position, then since the information which is recorded at its first film frame will not have been read out, it will be completely impossible to check the contents of this film.

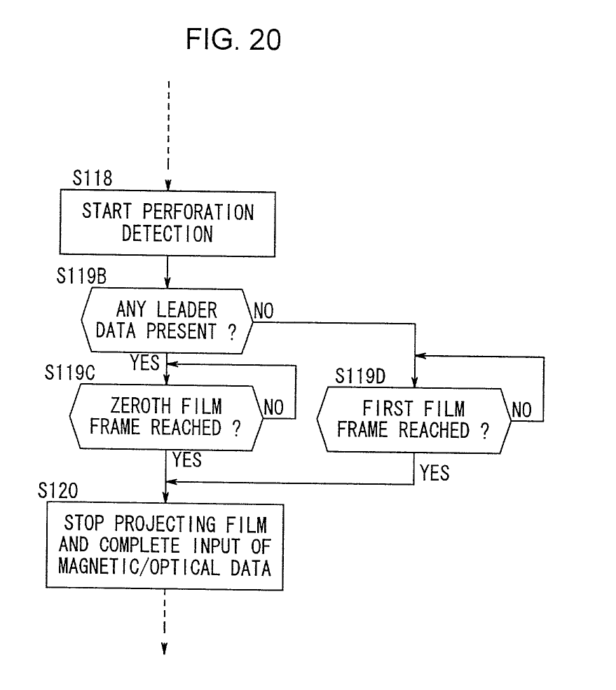

In this connection, in a variant embodiment which will now be explained whose partial flow chart is shown in FIG. 20 in a manner similar to that described above for the previous variant embodiment, a check is made during the initial forwarding of the film as to whether or not any information is recorded upon the leader portion of the film, and when information is indeed present upon the leader portion of the film then the film is advanced until its zeroth frame is positioned at the image formation position; while otherwise, if no information is present upon the leader portion of the film then the film is advanced until its first frame is positioned at the image formation position. Since this variant embodiment only differs from the preferred embodiment described above in a certain portion of the FIG. 6 flow chart for its main processing routine, the explanation herein will chiefly focus upon the points by which these embodiments differ.

The detection of the perforations in the film 3 starts in the step S118 from when the projection of the film 3 from the film cartridge 2 has started, and in the next step S119B a decision is made as to whether or not any data is actually recorded upon the leader portion of the film 3. If information actually has been read in from the leader portion of the film 3 by the magnetic head MH1 for playback and/or the optical read out device 11, then the flow of control proceeds to the step S119C, while if no such data has been read in from the film leader portion then the flow of control is transferred to the step S119D.

If in fact information was present upon the leader portion of the film 3, then in the step S119C a decision is made based upon the result of perforation detection as performed by the photointerruptors PH1 and PH2 as to whether or not the zeroth film frame has yet arrived at the image formation position. If the zeroth film frame has not yet arrived at the image formation position the flow of control loops back to this decision step S119C again, thus to continue waiting until in fact the zeroth film frame does arrive at the image formation position, at which point the flow of control proceeds to the next step S120, in which, along with stopping the further projection of the film 3 out of the film cartridge 2, the input of magnetic data and/or of optical data is completed. After this, the processing of the magnetic and/or optical data is performed in a manner identical to that in the preferred embodiment described above, and the information which has been thus read in from the leader portion of the film 3 is displayed upon the video monitor 23.

On the other hand, if no information was present upon the leader portion of the film 3, then in the step S119D a decision is made based upon the result of perforation detection as performed by the photointerruptors PH1 and PH2 as to whether or not the first film frame has yet arrived at the image formation position. If the first film frame has not yet arrived at the image formation position the flow of control loops back to this decision step S119D again, thus to continue waiting until in fact the first film frame does arrive at the image formation position, at which point the flow of control proceeds to the next step S120, in which, along with stopping the further projection of the film 3 out of the film cartridge 2, the input of magnetic data and/or of optical data is completed. At this time, it is possible to read out information that is recorded upon the first film frame upon the film 3, even if no information had been recorded upon the leader portion of the film3. After this, the processing of the magnetic and/or optical data is performed in a manner identical to that in the preferred embodiment described above, and the information which has been thus read in from the leader portion of the film 3 is displayed upon the video monitor 23.

Since in this manner, if no information other than an image is recorded on the leader portion of the film 3, the information other than an image which is recorded optically or magnetically on the first film frame is replayed and is displayed along with further forwarding the film so as to bring the first film frame to the image formation position, therefore the information relating to the contents of the film in a film cartridge which is loaded can be displayed before selection of a forwarding mode for the film, and accordingly the most suitable film forwarding mode for the contents of the film can be quickly and easily selected.

Another Variant Embodiment

In the above described preferred embodiment of the present invention, it has been shown by way of example that the film 3 is projected out of the film cartridge 2 and initial forwarding of the film 3 is performed so as to bring the first film frame to the image formation position in order to make it possible to check the contents of a film 3 which has been loaded and then subsequently to select the forwarding mode for the film 3. And also, in this example, the information other than an image which is magnetically or optically recorded on the leader portion of the film 3 is replayed, and this information other than an image which is magnetically or optically recorded on the leader portion of the film 3 and/or upon the first frame thereof is displayed so that the contents of the film 3 can be checked, without displaying an image of the first film frame which is positioned at the image formation position.

However, in the case of a film upon which no information other than photographic images is recorded upon the leader portion or for any of the film frames thereof, even if initial forwarding is performed so as to bring the first film frame to the image formation position, since no information for checking the contents of the film can be obtained from the leader portion or from the first film frame, such information cannot be displayed, and moreover an image of the first film frame is not displayed either. Accordingly in the above described preferred embodiment no display of any kind is provided in this case, which is not desirable.

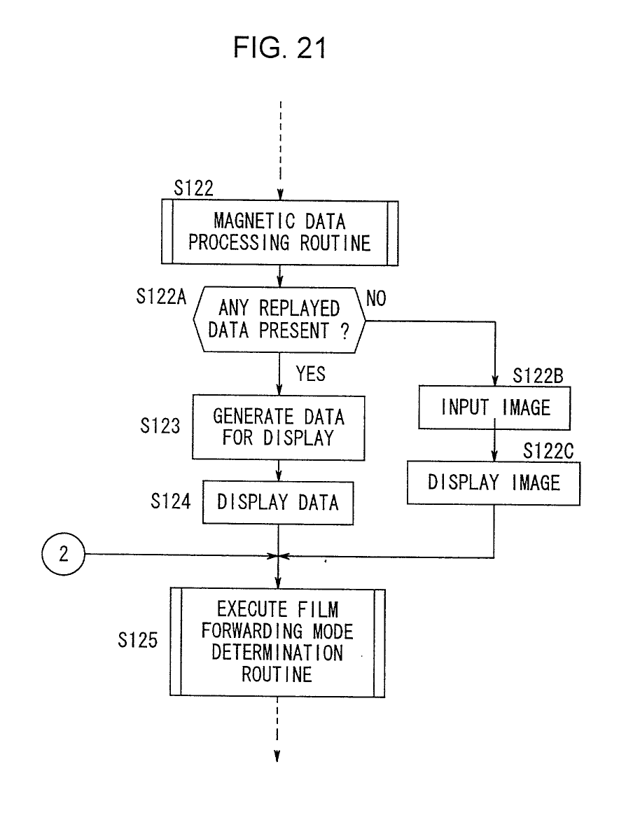

Accordingly, in another variant embodiment which will now be explained whose partial flow chart is shown in FIG. 21 in a manner similar to that described above for the previous variant embodiments, in the case that no information is replayed during the initial forwarding of the film up to the point at which the first film frame arrives at the image formation position, so that no information can be replayed from the leader portion of the film or from the portion thereof up to and including the first film frame, then such information, which is not available, is not displayed, but instead an image of the first film frame is displayed. Moreover, since this variant embodiment only differs from the preferred embodiment described above in a certain portion of the FIG. 7 flow chart for its main processing routine, the explanation herein will chiefly focus upon the points by which these embodiments differ.

As described above, in the steps S121 and S122 optical data processing and magnetic data processing are performed, and along with initially forwarding the film the magnetic and/or optical data which are obtained from the leader portion of the film and/or the first film frame are processed. In the next step S122A a decision is made as to whether or not any data was thus present and was replayed, and if data was present upon the leader portion of the film and/or the first film frame then the flow of control is transferred to the step S123 and the following steps, in which as described previously this information which was read out from the leader portion of the film and/or the first film frame during this initial forwarding is displayed.

On the other hand, if no data was present upon the leader portion of the film and/or the first film frame then the flow of control is transferred to the step S122B. In this step S122B an image of the first film frame is input via the CCD 9 and the image formation circuit 21, and in the next step S122C this image of the first film frame is displayed upon the video monitor 23.

In this manner, while the film 3 is being projected from the film cartridge 2 the information other than an image which is recorded upon the leader portion of the film and/or in the first film frame is replayed, and if no such information other than an image in fact is present upon the leader portion of the film and/or in the first film frame then the first film frame is brought to the image formation position and an image thereof is displayed upon the display device. Further, if information other than an image is magnetically or optically recorded upon the leader portion of the film, then the film is forwarded to the point one frame before the position at which the first film frame is positioned at the image formation position, i.e. to the position at which the zeroth film frame is positioned at the image formation position, and this information other than an image recorded upon the leader portion of the film is displayed; while, if no such information other than an image is magnetically or optically recorded upon the leader portion of the film while information other than an image is magnetically or optically recorded upon the first film frame, then the film is forwarded to the position at which the first film frame is positioned at the image formation position, and this information other than an image recorded upon the first film frame is displayed. By doing this, it is possible to deal both with films upon which such information other than an image is recorded and with films upon which no such information is recorded, and when a film cartridge containing a film of the former type is loaded, the film information relating to the contents of the film is displayed before the selection of the film forwarding mode, so that it is possible to select the most suitable forwarding mode for the film based upon the contents thereof which are thus known. On the other hand, when a film cartridge containing a film of the latter type is loaded, an image of the first frame upon the film is displayed before the selection of the film forwarding mode, so that it is possible to check upon the contents of the film by inspecting the first film frame, and again it is possible to select the most suitable forwarding mode for the film based upon the contents thereof which are thus known.

Yet Another Variant Embodiment

In the above described preferred embodiment of the present invention, it was shown by way of example that in the index mode information was read out from an information recording section which recorded the information other than images for all of the frames upon the film, and an index display was provided for this information for all of the film frames.

However, for a film upon which no such information is recorded, the execution of the index mode has no meaning.

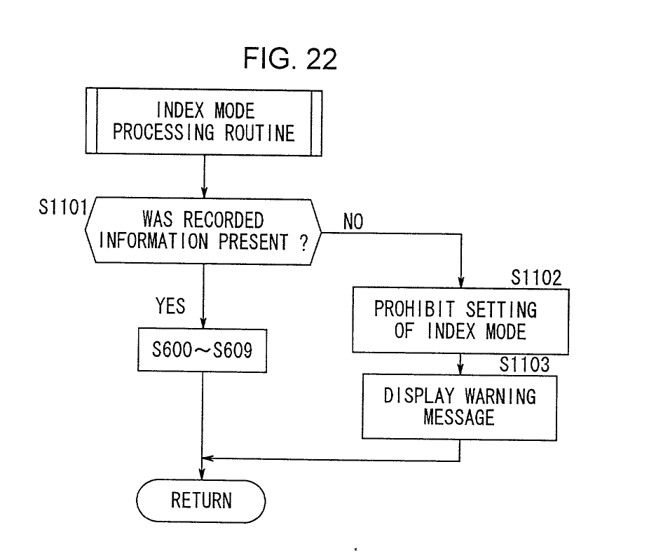

In this connection, in a variant embodiment which will now be explained whose partial flow chart is shown in FIG. 22 in a manner similar to that described above for the previous variant embodiments, matters are so arranged that replaying of the information other than an image is performed during the initial forwarding of the film, and if no recorded information is present then setting of the index mode is prohibited. Moreover, since this variant embodiment only differs from the preferred embodiment described above in a certain portion of the FIG. 15 flow chart for the index mode processing routine, the explanation herein will chiefly focus upon the points by which these embodiments differ.

When the main routine whose flow chart is shown in the above FIGS. 5 through 7 is executed, the information other than an image is replayed and is stored in the memory 26 while the initial film forwarding is performed by projecting the film 3 out from the film cartridge 2 until the first film frame comes to arrive at the image formation position. And when the index mode switch SW7 is operated so as to set the index mode, the microcomputer 20 executes the index mode processing routine whose flow chart is shown in FIG. 22.

In the first step S1101, a decision is made as to whether or not information other than an image was replayed from the leader portion of the film and/or the first film frame during the initial forwarding of the film. If in fact such information was present upon the leader portion of the film and/or the first film frame, then it is deemed that this is a film 3 of a type in which such information other than an image is recorded for each of the frames upon the film, and accordingly the flow of control is transferred to the steps same as the steps S600 through S609 of the FIG. 15 flow chart described above, in which the information for each of the film frames is replayed and an index is displayed upon the video monitor 23.

On the other hand, in the case that no such information was present upon the leader portion of the film and/or the first film frame, then it is deemed that this is a film 3 of a type in which no information other than images is recorded, and accordingly the flow of control is transferred to the step S1102, in which the setting of the index mode is prohibited, and then the flow of control proceeds to the step S1103, in which a warning operational message such as “Index mode cannot be selected because this is a film upon which no information is recorded” is displayed upon the video monitor 23.

In this manner, since the construction is such that the magnetic information for the first film frame is replayed while the film 3 is initially being forwarded until the first film frame arrives at the image formation position, and if no magnetic information is replayed from the first film frame then the setting of the index mode is prohibited, accordingly unnecessary operation such as winding on a film upon which no such information is recorded to its last film frame in the index mode, is prevented.

Further, since the construction is such that a warning is issued in addition to prohibiting of the setting of the index mode if no such information has been magnetically replayed from the first film frame, therefore it is possible to check if a film upon which no such information is recorded has been loaded into this film image signal generation apparatus.

Yet Another Variant Embodiment

As described above, the index mode is a mode for selecting one or more film frames of which the image is to be inspected, and in this index mode the information other than images recorded for all the film frames is read in and is displayed, and the operator then views the thus displayed index information for all of the film frames.

In the above described preferred embodiment of the present invention, the construction was such that, when the index mode was selected, the information was read in by forwarding the film as far as the final film frame thereupon while replaying the information other than images present thereupon; but in fact the shot film frames are not necessarily to continuing as far as the final film frame, since the case of a film which has been removed from the camera part way through exposure thereof and has then been developed should also be considered. Since with this sort of part way removed film images and information other than images are not recorded thereupon as far as the final film frame, accordingly in the index mode there is no meaning in winding on such a film as far as the final film frame thereof.

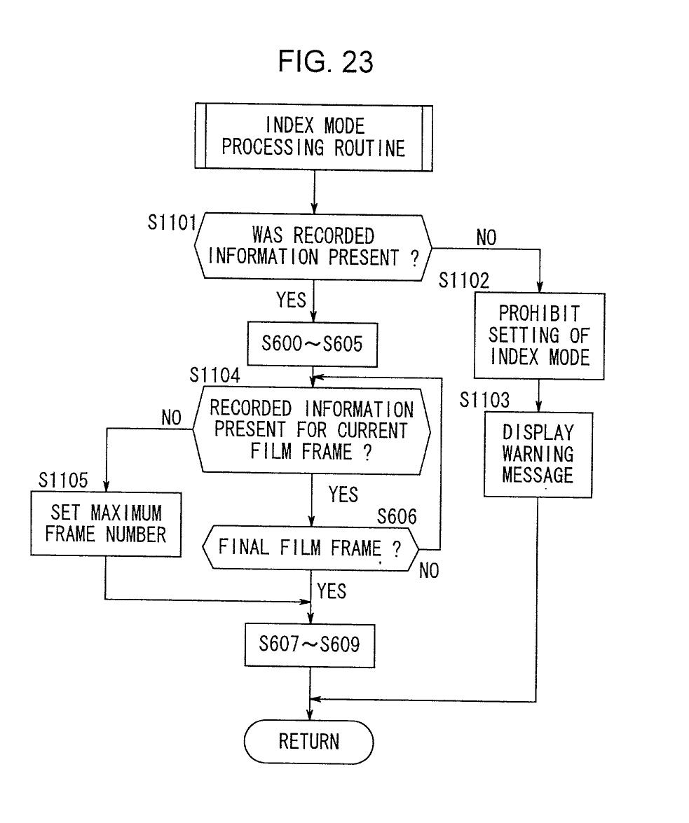

In this connection, in a variant embodiment which will now be explained whose partial flow chart is shown in FIG. 23 in a manner similar to that described above for the previous variant embodiments, matters are so arranged that the film frame of the maximum number for which information other than an image is recorded is taken as being the final film frame, and the film is forwarded as far as this final film frame while reading in the information from all the film frames which have been shot. Moreover, since this variant embodiment only differs from the preferred embodiment described above in a certain portion of the FIG. 15 flow chart for the index mode processing routine, the explanation herein will chiefly focus upon the points by which these embodiments differ.

In the first step S1101, a decision is made as to whether or not information other than an image was replayed from the leader portion of the film and/or the first film frame during the initial forwarding of the film 3. If in fact no such information was present upon the leader portion of the film and/or the first film frame, then it is deemed that this is a film 3 of a type in which no information other than images is recorded, and accordingly the flow of control is transferred to the step S1102, in which the setting of the index mode is prohibited, and then the flow of control proceeds to the step S1103, in which a warning operational message such as “Index mode cannot be selected because this is a film upon which no information is recorded” is displayed upon the video monitor 23.

On the other hand, in the case that such information was present upon the leader portion of the film and/or the first film frame, then it is deemed that this is a film 3 of a type in which such information other than an image is recorded for each of the frames upon the film, and accordingly the flow of control is transferred to the steps same as the steps S600 through S605 of the FIG. 15 flow chart described above, and the winding on of the film and the replaying of information therefrom are started. In the step S1104 the presence or absence of recorded information for the current film frame is checked, and if recorded information other than an image is present for the current film frame then the current film frame is deemed to be one which has been shot and the flow of control continues to the step S606, while if no recorded information is present for the current film frame then the current film frame is taken to be a non exposed film frame and the flow of control is transferred to the step S1105. If such recorded information is present for the current film frame, then in the step S606 a decision is made as to whether or not this is the final film frame according to the specification of the film, and if it is in fact the final film frame then the flow of control is transferred to the steps same as the above described steps S607 through S609 of the FIG. 15 flow chart and the information for all the film frames is indexed and is displayed; while, if this is not yet the final film frame, then the flow of control returns to the step S1104.

On the other hand, if no such information is present for the current film frame which is accordingly an unexposed film frame, then in the step S1105, since the series of film frames up to one frame before the film frame for which no recorded information was detected are the shot film frames for which recorded information exists, this film frame is set as being the highest numbered film frame, i.e. the final film frame. Moreover, the frame which is set in this index mode as being the final film frame becomes valid for all subsequent forwarding for the film, and forwarding of the film is performed over the range from the first film frame to this set final film frame which has been exposed. After setting the final film frame, the flow of control is transferred to the steps same as the above described steps S607 through S609 of the FIG. 15 flow chart, and the information for all the film frames which have been exposed is indexed and is displayed.

In this manner, since the construction is such that the magnetic information for each film frame is replayed while the film is being forwarded, and the film frame of the maximum number for which magnetic information is replayed is set as being the final frame of the film, accordingly useless operation for forwarding non exposed film frames to the image formation position is prevented. Further, since the construction is such that the film is subsequently forwarded over the range from the first film frame to this film frame of the maximum number for which magnetic information is replayed which is set as the final film frame, therefore useless operation for forwarding non exposed film frames to the image formation position is prevented for all of the film forwarding modes, including this index mode.

Although the present invention has been shown and described in terms of the preferred embodiment and variations thereof, it is not to be considered as limited by any of the perhaps quite fortuitous details of said embodiments or of the drawings, but only by the terms of the appended claims, which follow.

What is claimed is:

1. A film image signal generation apparatus, comprising:
an image taking up device which takes up an image upon a developed film which is stored in a cartridge and outputs an image signal;
a moving device which moves said film to said image taking up device;
a determination circuit which determines whether or not a final film frame on said film is set to an image formation position of said image taking up device; and
a prohibition circuit which, when it has been determined by said determination circuit that said final film frame is set to said image formation position, prohibits winding on of said film from said cartridge by said moving device.

2. A film image signal generation apparatus, comprising:
an image taking up device which takes up an image upon a developed film which is stored in a cartridge and outputs an image signal
a moving device which moves said film to said image taking up device;
an operation member which designates winding on of said film from said cartridge by said moving device;
a determination circuit which determines whether or not a final film frame on said film is set to an image formation position of said image taking up device; and
a warning device which emits a warning when said operation member is operated when it has been determined by said determination circuit that said final film frame is set to said image formation position.

3. A film image signal generation apparatus according to claim 2, wherein said operation member designates winding forward of said film by one film frame.

4. A film image signal generation apparatus according to claim 2, wherein said operation member designates fast winding forward of said film.

5. A film image signal generation apparatus, comprising:
an image taking up device which takes up an image upon a developed film which is stored in a cartridge and outputs an image signal;
a moving device which moves said film to said image taking up device;
a determination circuit which determines whether or not a first film frame on said film is set to an image formation position of said image taking up device; and
a prohibition circuit which, when it has been determined by said determination circuit that said first film frame is set to said image formation position, prohibits winding backward of said film into said cartridge by said moving device.

6. A film image signal generation apparatus, comprising:
an image taking up device which takes up an image upon a developed film which is stored in a cartridge and outputs an image signal;
a moving device which moves said film to said image taking up device;
an operation member which designates winding backward of said film into said cartridge by said moving device;
a determination circuit which determines whether or not a first film frame on said film is set to an image formation position of said image taking up device; and
a warning device which emits a warning when said operation member is operated when it has been determined by said determination circuit that said first film frame is set to said image formation position.

7. A film image signal generation apparatus according to claim 6, wherein said operation member designates winding backward of said film by one film frame.

8. A film image signal generation apparatus according to claim 6, wherein said operation member designates fast rewinding of said film.

9. A film image signal generation apparatus, comprising:
an image taking up device which takes up an image upon a developed film which is stored in a cartridge and outputs an image signal;
a moving device which moves said film to said image taking up device;
an operation member which is capable of setting a forwarding mode for outputting of image signals by said image taking up device while winding forward said film from said cartridge one film frame at a time by said moving device;
a determination circuit which determines whether or not a first film frame on said film is set to an image formation position of said image taking up device; and
a control circuit which controls said image taking up device to output an image signal of said first film frame when said forwarding mode is set by said operation member and when it is determined by said determination circuit that said first film frame is set to said image formation position, and which controls said moving device to wind on said film by one film frame when said forwarding mode is set by said operation member and when it is determined by said determination circuit that said first film frame is not set to said image formation position.

10. A film image signal generation apparatus, comprising:
an image taking up device which takes up an image upon a developed film which is stored in a cartridge and outputs an image signal;
a moving device which moves said film to said image taking up device;
an operation member which is capable of setting a first forwarding mode for winding forward said film from said cartridge by said moving device until a first film frame of said film is set to an image formation position of said image taking up device, and a second forwarding mode for outputting image signals by said image taking up device while winding forward said film from said cartridge one film frame at a time by said moving device; and
a control circuit which controls said image taking up device to output an image signal of said first film frame when said second forwarding mode has been set after said first forwarding mode has been set and said first film frame has been set to said image formation position by said operation member.

11. A film image signal generation apparatus, comprising:
an image taking up device which takes up an image upon a developed film which is stored in a cartridge and outputs an image signal;
a moving device which moves said film to said image taking up device;
an operation member which is capable of setting a forwarding mode for outputting image signals by said image taking up device while winding backward said film into said cartridge one film frame at a time by said moving device;
a determination circuit which determines whether or not a final film frame on said film is set to an image formation position of said image taking up device; and
a control circuit which controls said image taking up device to output an image signal of said final film frame when it is determined by said determination circuit that said final film frame is set to said image formation position and when said forwarding mode is set by said operation member, and which controls said moving device to wind said film backward by one film frame when it is determined by said determination circuit that said final film frame is not set to said image formation position and when said forwarding mode is set by said operation member.

12. A film image signal generation apparatus, comprising:
an image taking up device which takes up an image upon a developed film which is stored in a cartridge and outputs an image signal;
a moving device which moves said film to said image taking up device;
an operation member which is capable of setting a first forwarding mode for winding forward said film from said cartridge by said moving device until a final film frame of said film is set to an image formation position of said image taking up device, and a second forwarding mode for outputting image signals by said image taking up device while winding backward said film into said cartridge one film frame at a time by said moving device; and
a control circuit which controls said image taking up device to output an image signal of said final film frame when said second forwarding mode has been set after said first forwarding mode has been set and said final film frame has been set to said image formation position by said operation member.

13. A film image signal generation apparatus, comprising:
an image taking up device which takes up an image upon a developed film which is stored in a cartridge and outputs an image signal;
a moving device which moves said film to said image taking up device;
an information replay device which replays information which is magnetically recorded on a recording area of each film frame of said film; and
a control circuit which controls said information replay device to replay said information for each film frame while said film is being moved to a final film frame thereof by said moving device, and which outputs a replayed information signal for each film frame upon said display means.

14. A film image signal generation apparatus according to claim 13, further comprising an information storage means which stores said information for each film frame replayed by said information replay device.

15. A film image signal generation apparatus according to claim 14, wherein said control circuit controls said information replay device to replay information only for film frames for which information is not stored in said information storage means.

16. A film image signal generation apparatus according to claim 15, wherein said information replay device comprises a mechanism which performs contacting of a magnetic head to said film and removal of said magnetic head from said film, and said control circuit, when said film is being moved by said moving device, contacts said magnetic head to said film only for film frames for which information is not stored in said information storage means.

17. A film image signal generation apparatus according to claim 13, wherein said final film frame is a maximum numbered film frame for which information is magnetically recorded.

18. A film image signal generation apparatus, comprising:
an image taking up device which takes up an image upon a developed film which is stored in a cartridge and outputs an image signal;
a moving device which moves said film to said image taking up device;
an operation member for designating any film frame; and
a control circuit which controls said moving device to move said film frame which is designated by said operation member to said image taking up device

19. A film image signal generation apparatus according to claim 18, further comprising:
a film frame number detection means which detects a maximum film frame number of said film, and wherein
said control circuit emits a warning if said film frame which is designated by said operation member exceeds said maximum film frame number detected by said film frame number detection means.

20. A film image signal generation apparatus according to claim 18, further comprising:,
an information replay device which replays information which is magnetically recorded on a recording area of each film frame of said film; and
an information storage circuit which stores said information for each film frame replayed by said information replay device, wherein
said control circuit controls information replay operation by said information replay device only for film frames for which information is not stored in said information storage circuit.

21. A film image signal generation apparatus according to claim 20, wherein:
said information replay device comprises a mechanism which performs contacting of a magnetic head to said film and removal of said magnetic head from said film; and
said control circuit, when said film is being moved by said moving device, contacts said magnetic head to said film only for film frames for which information is not stored in said information storage circuit.

22. A film image signal generation apparatus according to claim 19, wherein said maximum film frame number is a maximum film frame number among exposed film frames.

23. A film image signal generation apparatus, comprising:
an image taking up device which takes up an image upon a developed film which is stored in a cartridge and outputs an image signal;
a moving device which moves said film to said image taking up device; and
an information replay device which, in a process of initial forwarding of said film by projecting said film out from said cartridge, controls moving so as to bring a first film frame of said film to said image taking up device, and which in response to this operation replays information which is recorded on a recording area of said first film frame of said film.

24. A film image signal generation apparatus according to claim 23, wherein a signal corresponding to said information for said first film frame which has been replayed is outputted without outputting an image signal of said first film frame which has been positioned by said initial forwarding process.

25. A film image signal generation apparatus according to claim 23, wherein said information replay device also replays another information which is magnetically recorded in a leader portion of said film.

26. A film image signal generation apparatus according to claim 25, wherein a signal corresponding to said information for said first film frame and said another information for said film leader portion which have been replayed is outputted without outputting said image signal of said first film frame which has been positioned by said initial forwarding process.

27. A film image signal generation apparatus according to claim 23, wherein said information which is recorded upon said film is magnetically recorded information.

28. A film image signal generation apparatus according to claim 23, wherein said information which is recorded upon said film is optically recorded information.

29. A film image signal generation apparatus, comprising:
an image taking up device which replays an image upon a developed film which is stored in a cartridge and outputs an image signal;
an information replay device which replays information other than images which is recorded upon said film;
a moving device which moves said film; and
a control circuit which controls said moving device to project said film from said cartridge and move said film so as to bring a portion thereof one frame towards a leader portion thereof from a first film frame thereof to said image taking up device, controls said information replay device to replay information other than images which is recorded upon said leader portion of said film, and outputs a signal corresponding to said information.

30. A film image signal generation apparatus according to claim 29, wherein said control circuit, when no information other than images is recorded upon said leader portion of said film, controls said moving device to move said film so as to bring said first film frame thereof to said image taking up device, controls said information replay device to replay information other than images which is recorded on a recording area of said first film frame of said film, and outputs a signal corresponding to said information.

31. A film image signal generation apparatus according to claim 29, wherein information other than images which is recorded upon said film is magnetically recorded information.

32. A film image signal generation apparatus according to claim 29, wherein information other than images which is recorded upon said film is optically recorded information.

33. A film image signal generation apparatus, comprising:
an image taking up device which replays an image upon a developed film which is stored in a cartridge and outputs an image signal;
an information replay device which replays information which is magnetically recorded on a recording area of each film frame of said film;
a moving device which moves said film; and
a final film frame setting circuit which sets a highest numbered film frame, where magnetically recorded information has been replayed by said information replay device while moving said film by said moving device, as a final film frame of said film.

34. A film image signal generation apparatus according to claim 33, wherein said moving device moves said film within a range from a first film frame to said final film frame set by said final film frame setting circuit.

35. A film image signal generation apparatus, comprising:
an image taking up device which takes up an image upon a developed film which is stored in a cartridge and outputs an image signal;
a moving device which moves said film to said image taking up device;
an information replay device which replays information which is magnetically recorded on a recording area of each film frame of said film;
an information storage circuit which stores said information for each film frame replayed by said information replay device; and
a control circuit which, when said film is being moved by said moving device, controls information replay operation by said information replay device only for film frames for which information is not stored in said information storage circuit.

36. A film image signal generation apparatus according to claim 35, wherein:
said information replay device comprises a mechanism which performs contacting of a magnetic head to said film and removal of said magnetic head from said film; and
said control circuit, when said film is being moved by said moving device, contacts said magnetic head to said film only for film frames for which information is not stored in said information storage circuit.

37. A film image signal generation apparatus according to claim 35, wherein said moving device has:
a first forwarding mode in which said moving device moves said film one frame at a time;
a second forwarding mode in which said moving device moves any film frame of said film to said image taking up device; and
a third forwarding mode in which said moving device moves said film to a final film frame thereof in order to replay and store said information for all of said film frames upon said film.

38. A film image signal generation apparatus, comprising:
an image taking up device which replays an image upon a developed film which is stored in a cartridge and outputs an image signal;
an information replay device which replays information other than images which is recorded upon said film;
a moving device which moves said film; and
a control circuit which controls said moving device to project said film out from said cartridge, controls said information replay device to replay information other than images recorded in a leader portion of said film and in a first film frame thereof, and, when no information other than images is recorded in said leader portion of said film or in said first film frame thereof, controls said moving device to move said first film frame to said image taking up device, and outputs an image signal of said first film frame.

39. A film image signal generation apparatus according to claim 38, wherein said control circuit (1) if information other than images is recorded in said leader portion of said film, controls said moving device to forward said film so as to bring a portion thereof one frame towards said leader portion thereof from said first film frame thereof to said image taking up device, and outputs a signal corresponding to information other than images which is recorded upon said leader portion of said film, and (2) if no information other than images is recorded in said leader portion of said film but information other than images is recorded on a recording area of said first film frame of said film, controls said moving device to forward said film so as to bring said first film frame thereof to said image taking up device, and outputs a signal corresponding to information other than images which is recorded upon said first film frame of said film.

40. A film image signal generation apparatus according to claim 38, wherein information other than images which is recorded upon said film is magnetically recorded information.

41. A film image signal generation apparatus according to claim 38, wherein information other than images which is recorded upon said film is optically recorded information

42. A film image signal generation apparatus, comprising:
an image taking up device which replays an image upon a developed film which is stored in a cartridge and outputs an image signal;
an information replay device which replays information which is magnetically recorded on a recording area of each film frame of said film;
a moving device which moves said film;
an index mode setting circuit which sets an index mode in which said magnetically recorded information for each film frame is replayed by said information replay device while moving said film by said moving device as far as a final film frame thereof, and then a signal corresponding to said magnetically recorded information for each film frame which has been replayed is outputted; and
a control circuit which controls said moving device to move a first film frame of said film to an image formation position of said image taking up device, and controls said information replay device to replay said magnetically recorded information for said first film frame of said film, and which prohibits setting of said index mode if no said magnetically recorded information has been replayed from said first film frame.

43. A film image signal generation apparatus according to claim 42, wherein said control circuit emits a warning via said display means when no said magnetically recorded information has been replayed from said first film frame of said film.
